(19) United States
(12) Patent Application Publication
(10) Pub. No.: US 2010/0236763 A1
(43) Pub. Date: Sep. 23, 2010

(54) THERMAL OUTER COVER WITH GAS BARRIERS

(76) Inventor: Arpad Torok, Oradea (RO)

Correspondence Address: Torok Arpad, Str Transilvaniei nr 29, Oradea, Jud Bihor, RO

(21) Appl. No.: 12/224,343

(22) PCT Filed: Aug. 7, 2006
(86) PCT No.: PCT/RO2006/000015

§ 371 Date: Jun. 2, 2010

(30) Foreign Application Priority Data
Aug. 10, 2005 (RO) A2005 00695
Mar. 27, 2006 (RO) A2006 00199

(51) Int. Cl. F28F 13/00; E04B 1/74; B32B 3/18; E04B 1/78

(52) U.S. Cl. 165/121; 428/72; 428/69; 428/12; 428/34.1; 52/169.11

(57) ABSTRACT

This invention is describing a procedure for building constructions, tanks, technological installations, etc., characterized by constructing around the building an additional supra-structures (FIG. 1b, 1g) avoiding the contacts with the first supra-structure and which supports a thermo insulating outer cover (1d), the components of the exterior installations (1j) and decorative elements (1k). For applying this procedure the invention is proposing a series on new procedures and construction materials: multi layered barriers (1d, made of gas layers with optimal thickness, support layers with the minimal thickness allowed by the producing technology or by the mechanical forces, spacers and an outside layer), thermos barriers (1f, made of a gas layer, saturated gas layer or vacuum, bordered by a frame and two reflecting support layers), variable resistance barriers, active barriers (1g, thermos layer with a positive or negative heat source), solar barriers (1h); thermo insulating foils (1g), plates (1h) and sheets (with 95% of volume being gas), multilayered plated with supervised central void, thermo insulating bricks (1c) with plane surfaces decorated, with faience, enameled, bricks for porous walls (for recovering the heat from the evicted air), detachable bricks, insulating window wall surfaces transparent or semi-transparent, pre-insulated pipes and fittings, different types of heat exchangers (1g), electrical, with air, with water or with fridge agent, heat economizers with fridge agent, panels (1m), lamellas (1l) and solar tubes, classical or with cold surfaces.

This invention describes a procedure for building living spaces, social buildings and industrial spaces, applicable for both new buildings and the existent ones, using gas film layers as thermo barriers embedded into their structure. Materials used for applying the procedure are obtained through new technologies or by improving the current ones, by incorporating thermal gas film barriers. The barriers can be also used in technological installations where thermal processes appear, as well as for manufacturing clothes or equipments with thermo-insulating properties. The invention describes also the manufacturing tools for producing those materials as well as the assembling procedures. By combined use of these materials and procedures, the invention is proposing a new method of building buildings and technological installations, with intensive use of non-conventional energies and minimum heat loss.

Current technical level: Gases are frequently used to produce thermo insulating materials in different forms:
air in closed spaces, on relatively large sizes, with relatively regular and predefined forms, perpendicular on the thermal flux direction, introduced inside the construction elements (clay bricks, concrete or mixes of those with different other materials) or inside thermo insulating elements (curled carton, layered materials). As the materials where these gas regions are built in have usually high thermal conductivity coefficients, the thermo resistance opposed by the gas regions is higher than the one opposed by a similar region in the base material
air or gas with lower thermal conductivity coefficient (carbon dioxide, Freon, vacuum) in closed regions with approximately spherical forms, with relatively small sizes, introduced inside materials with a good thermal resistance (cellular concrete, gyps cellular, porous bricks, polystyrene, polyurethane, polyethylene, natural or synthetic rubber. Similar materials are also available in natural forms: volcanic tuff, pounce stone, cork, etc.
air in reduced spaces with non-regular open forms and with communication spaces among them or between them and exterior, introduced among solid fragments in the form of dust, corns, balls, sawdust, woodchips, boring dust, flakes, cottars, natural or artificial fibers.
air in closed or open filmed regions, (with one dimension much smaller than the other two), perpendicular on the thermal flux direction, with high thickness (between glass layers, inside glass bricks, etc) or small thickness (layered materials, alfol, etc).

From thermal transfer resistance point of view, the last procedure is the most efficient one, but it requires many gas films and their thickness has to be optimal. International brevet WO 00/16971 (PCT/SK99/00014) is proposing a multi-layered insulation system by using a large number of gas layers with thickness where convention becomes negligible, made by producing slots (by laser cutting, chemical erosion, extrusion) in a thermo insulating block material. The international brevet WO 98/09104 (PCT/DE97/01901) is proposing a multi-layered material made of thin gas layers separated by thin solid layers separated by very thin fiber spacer perpendicular on the support layer. In both cases building the filmed configuration brings a series of technical and economical problems difficult to overcome.

From construction building technology point of view there are some procedures that are embedding large air spaces at normal pressure in non-regular or filmed forms between two walls, in building some ceilings with prefabricated strips with gouges or in building fake ceilings, curtain and double-skin walls, the walls of train cars or the walls of several installations or tools, but their efficiency is relatively low. The materials with reflection properties towards thermal radiations are only used on the external surface of some insulating materials or for shielding and alfol creation, while thermal exchangers are mainly installed on the interior or exterior side of outside walls. Radiant floors and radiant walls are usually part of the surface they are installed on, heat pomp collectors are usually installed in the ground or on the exterior walls, and solar panels are usually installed on the building roofs in a fixed position and have large sizes and weights incorporating a large quantity of thermal insulation and retaining a small portion of diffuse radiation.

The technical problem: For thermo insulating materials that contain one of the above mentioned gas regions, the thermal resistance of the final product is increasing with the percentage of volume of the gas regions in the volume of the final product and with the thermal resistance transfer coefficients for both the base material and the gas used (considering also the thermal convection phenomenon). Those are the elements that the procedures described in this invention are optimizing. Unlike the procedures currently used in technique, the procedures described in the invention are mainly using pellicle configuration, the most advantageous and overcoming several technical problems:
it increases the percentage of gas used in the total volume of the final product
it facilitates the usage easier and with higher efficiency of vacuum or other gases with superior thermo insulating properties
it offers an outside skin with special properties in facing the extreme conditions and with superior ease of usage, which translates into reduction of material quantity used, manpower cost and tool cost for their utilization
it creates the premises for applying procedures of heat loss cut due to thermal radiation.
it gives the possibility of recovering the heat from the air ejected from the buildings
it creates the conditions for building a variable thermo resistance
it creates the conditions for using climate control procedures with increased efficiency, with minimum heat loss and with high usage of non-conventional energies.
it, allows the usage of new, more efficient construction technologies
it allows large scale usage of waste materials
can be applied in producing clothes and thermo insulating equipments

Using the proposed insulating procedures and clime control systems allows one to apply new methods of designing and constructing the buildings that are creating an exterior thermal outer cover separated from the rest of the building by a thermal barrier which is incorporating elements for energy capture. In this outer cover the clime control installation built by an efficient combination of active and solar thermal barriers is perfectly integrated in the building structure and their building blocks become component parts of the building. In this way one can build real estates with walls, floors and ceilings warm in the winter and chilly in the summer without using visible pipes of heat exchangers neither on the outside nor the inside perimeter, majority of the energy being provided by non-conventional sources. Applying these procedures one can reduce heat loss from buildings and installations and consequently reducing the burn gases and carbon dioxide emanations in the atmosphere.

The examples of applying these procedures are referring to the following figures:

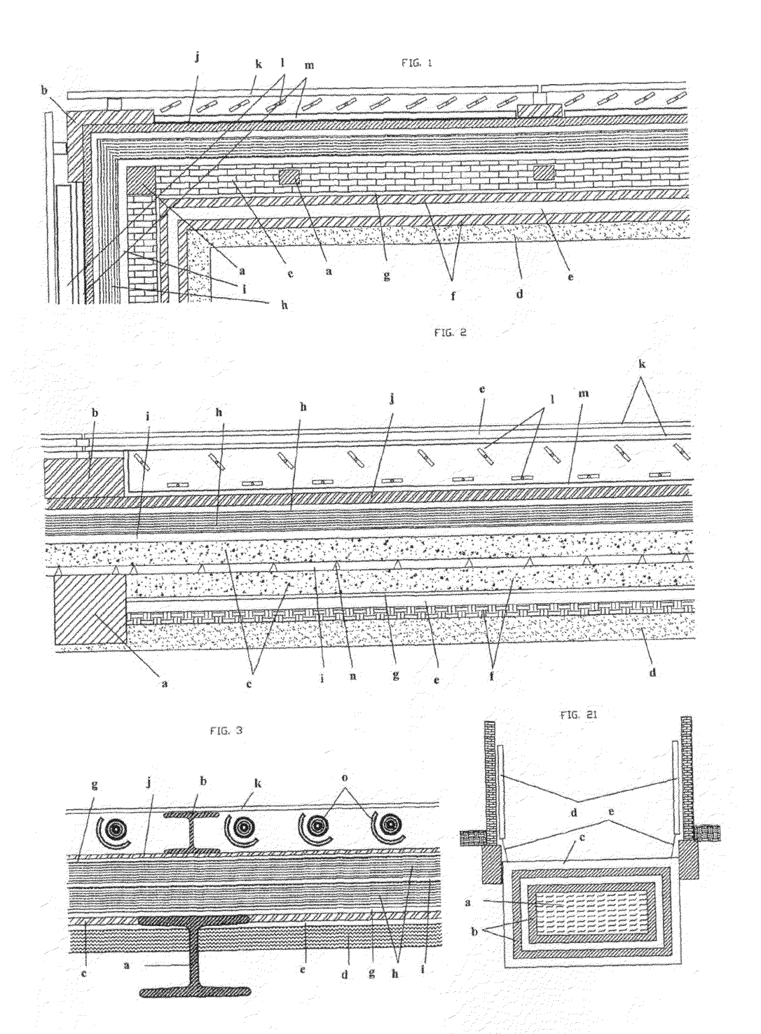

FIG. 1: outer covered structure with concrete pillars and brick walls

FIG. 2: outer covered structure with concrete walls and pillars

FIG. 3: outer covered structure with metallic pillars and walls

FIG. 4: procedure for producing thermo-insulating materials by farming

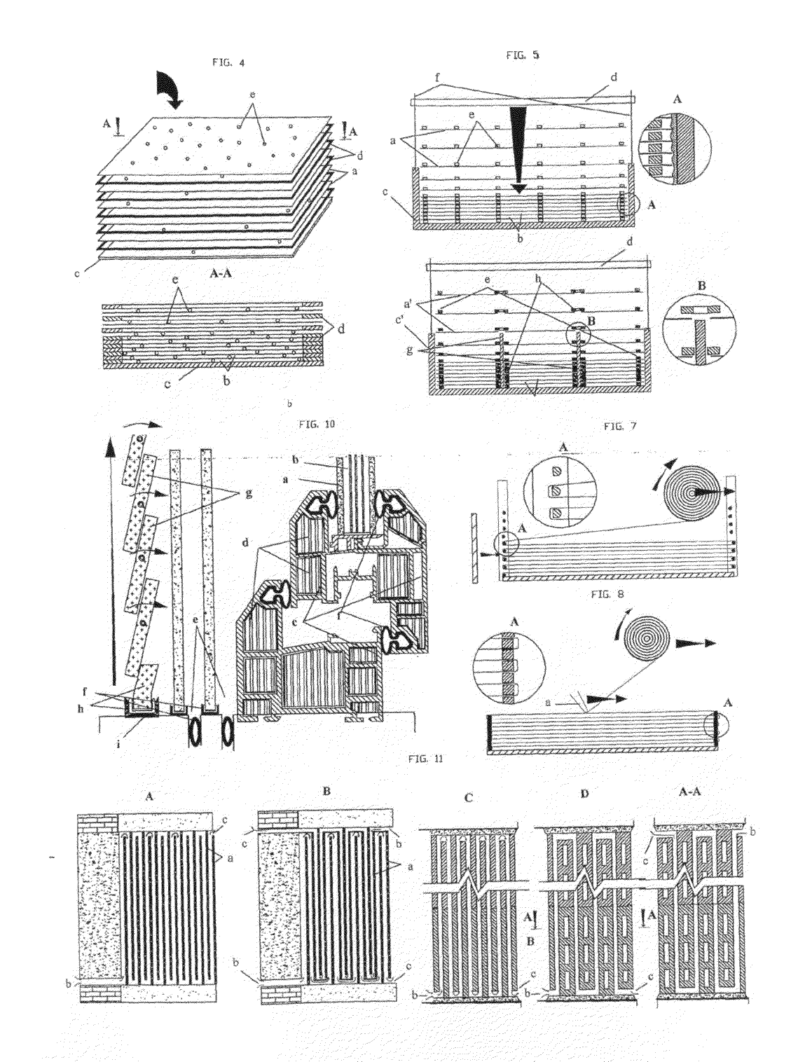

FIG. 5: procedure for producing thermo-insulating materials by encasing

FIG. 6: component elements of the materials produced by these procedures

FIG. 7: encasing procedure by stressing the support layer

FIG. 8: framing procedure by stressing the support layer

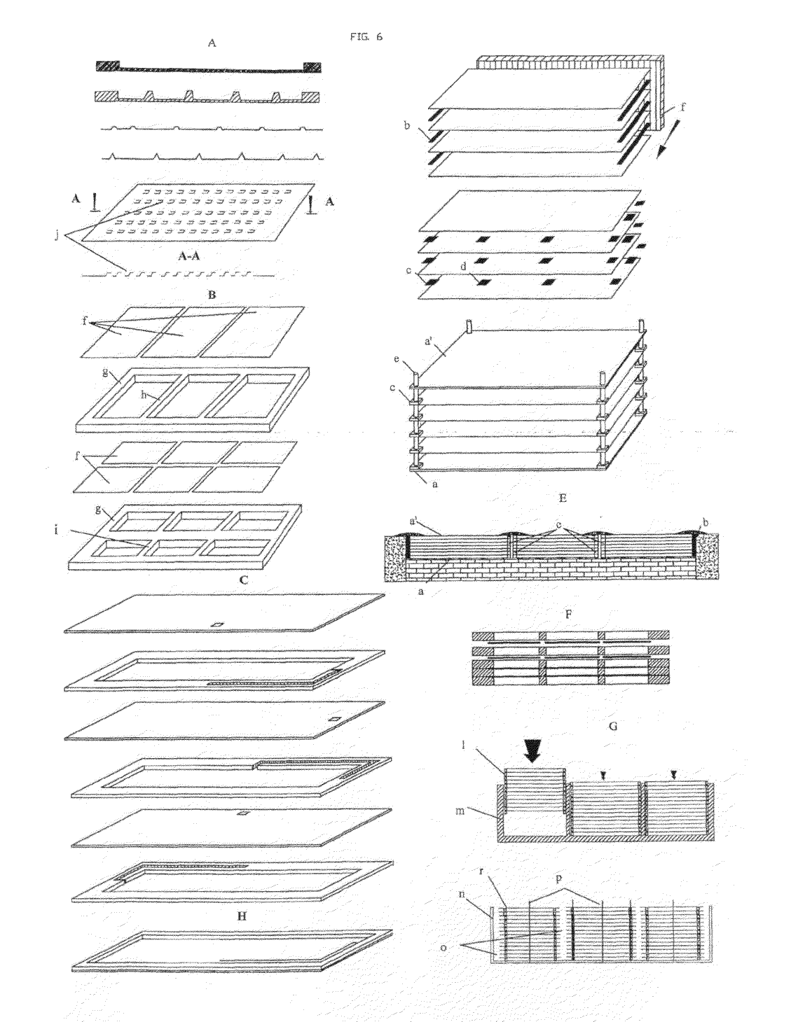

FIG. 9: thermo insulating plate profiles

FIG. 10: creating vitrified surfaces

FIG. 11: building porous walls

FIG. 12: bricks with modified vertical holes

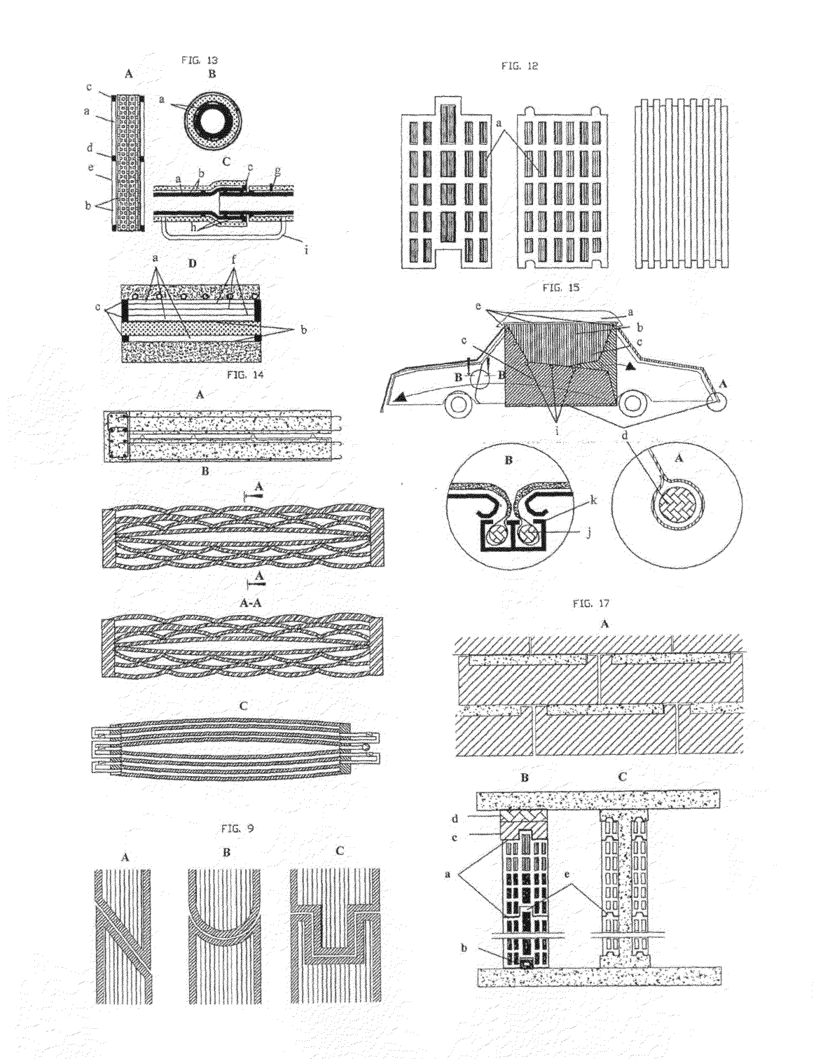

FIG. 13: building a thermos layer

FIG. 14: building vacuum barriers

FIG. 15: isolating a car

FIG. 16: installation with pressure chamber

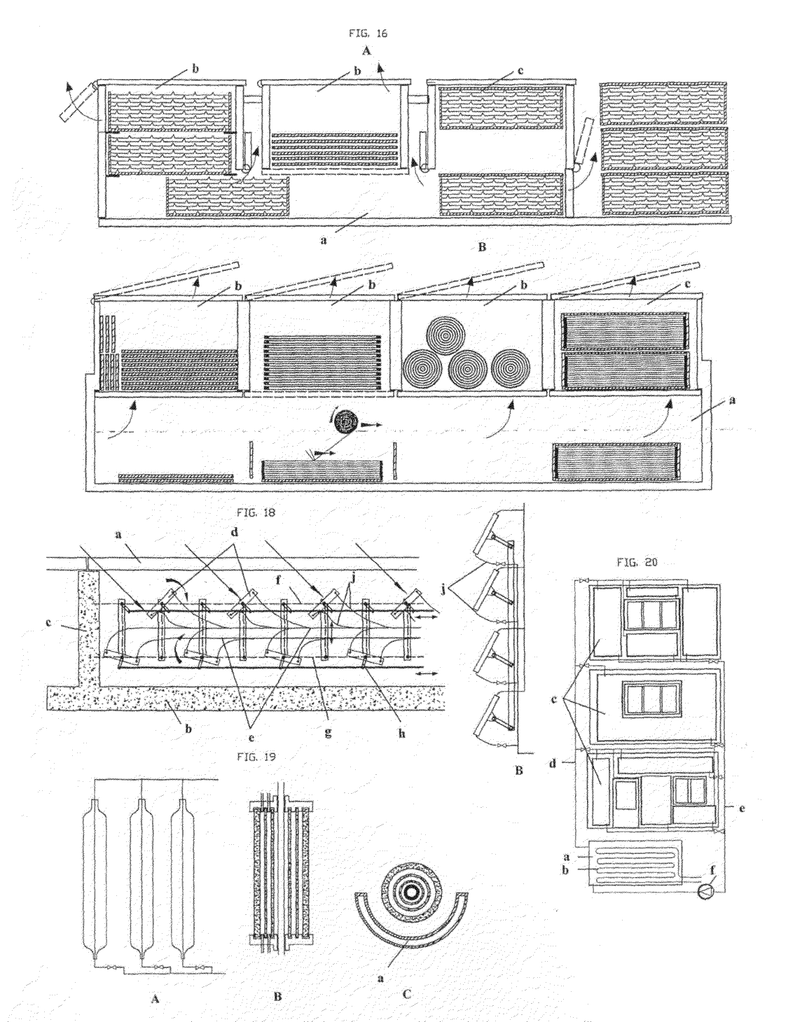

FIG. 17: new procedures for obtaining the bricks

FIG. 18: solar barrier with lamellas

FIG. 19: different types of solar tubes

FIG. 20: climate installation with fridge agent with tank

FIG. 21: air-ground heat economizer

Gas Film Thermal Barriers: Out of all substances used for producing thermal barriers, the gas has the lowest thermal conductivity coefficient as long as the gas region is thinner than the thickness of the convective layer bordering it. Once this limit of the thickness optimal for building thermo insulating materials is surpassed, the thermal transfer resistance of the gas region is increasing very slowly reported to increasing the thickness, due to convection heat transmission phenomenon that arises. This optimal thickness (with size order of tens of millimeters) is different from one gas to another, depends on the direction and orientation of the thermal flux and the absolute gas temperature and will be experimentally determined for each particular case. It's true that a single gas layer with this optimal size embedded in the building of a wall has a small contribution on its total thermal resistance. It is also true that the gas layer is efficient even if used on larger thickness because the thermal conductivity of wall building materials is high. The efficiency can be also increased by different procedures described in this invention:
using only gas layers with the size close to the optimal one, as many as possible, in order to significantly reduce convection heat losses (multi-layered barriers)
reducing the solid layers thickness as much as allowed, in order to significantly reduce conduction heat losses (multilayered barriers)
using gases with thermal conductivity coefficient smaller than the air one, in order to reduce conduction heat losses (multilayered barriers and thermos barriers)
using vacuum, wherever this is possible and economically profitable, in order to reduce both convection and conduction heat losses (vacuum barriers)
using reflection surfaces in order to reduce reflection heat losses (thermos barriers, vacuum bathers, multi layered barriers with transparent support layer)
using heat sources inside the gas barrier in order to positively modify the superficial thermal transfer coefficient, the thermal flux densities, the convection coefficient and the conductivity coefficient (active barriers)

The Multilayered Barriers are obtained by alternating a large number of gas layers (base layer; FIGS. 4b, 5b) with solid layers (support layer; 4a, 5a) which can be plates of hard materials or foils of soft materials. According to this invention the barriers can be used for:
producing thermo insulating materials via new procedures, using base layers with optimal thickness, by introducing some frames and/or spacers with this thickness between support layers. In order to reduce the weight of volume of solid elements in the total volume, the thickness of the support layer has to be as small as possible: the limit allowed by manufacturing techniques, or where mechanical pressure appears, the limit required for mechanical resistance. As well, total volume of the spacing solid materials has to be as small as possible. Using hard materials plates leads to reduce the number of spacer, and using foils, if they are perfectly tighten or even slightly under tension (by sticking the hard frame on a tightened support layer, FIG. 8, in framing procedure or by fixing the corners using tensing bars fixed in the protective plates, FIG. 6D), or by sticking them on the case walls previously tensioned using tension teeth, FIG. 7 for encasing procedure or open frame procedure) one can reach to eliminate the usage of such spacers. The composition and sizes of the frames and the spacers and even for the adhesives used for joints are chosen based on their thermo bridge effect. The procedures described in this invention can lead to a gas volume weight in the total volume higher than 90%. In those circumstances the thermo conductivity coefficient of the solid elements has a reduced weight in the global conductivity coefficient, thus the support layer role is only to separate the base layers, and the materials used are chosen based on different other criteria, considering mainly the possibility of its lamination at small thickness, on micron order: polyethylene, PVC, nylon, other plastic materials, paper, glass, metal foils, mica, polymers, rubber, resins, dense woven of natural or artificial silk, or other types of very thin fibers. Upon choosing the right material for support layers, they can fulfill different other roles as well: vapors barrier, diffusion layer, strengthening layer, layer for thermo radiation reflection, etc. The thermo conductivity coefficient of the base layer becomes extremely important, thus justifying the usage of gases with conductivity coefficient as small as possible or even usage of vacuum.

For keeping a constant thickness of the base layers (and in some particular cases for gas pellicle fragmentation) one can use perimeter frames, one piece (4d) or fragmented (6D) or/and punctiform spacer (4e, 5e), linear spacer (6h) or in form of a grill (6i). Perimeter frames, together with the exterior support layers (protective layers) make the skin of the final product (framing procedure). The exterior skin can be as well a case (made of hard or shapeable materials; 5c) where all those layers and spacer are introduced, in (encasing procedure). One can apply to this external skin that can be made of the most suitable materials considering the latter usage, completely different vs. the base structure, different processing in order to make it easy usable in the given conditions. Thus, very good thermo insulating materials (Polystyrene, cotton wool, paper, textiles, flakes, etc) but with low resistance on static compression and environmental agents can be used in the toughest situations. Having this outside layer that can be treated to become impermeable for some gases or to resist to high pressure, makes the usage of any gas as base layer possible, even if at high pressure or advanced vacuum. As well, it allows the usage materials with small communicating air regions (obtained by waste materials recovery or by using fibers and wires) where one is obtaining superior thermal resistance by replacing the air with a better insulating gas.

By overlapping and soldering the frames and the support layers, or by tightening them between two protective plates (as in framing procedure), or by introducing the support layers and spacing elements in thin walls cases with the wanted size and shape (encasing procedure) one can obtain thermo insulating materials in a form of plates (for hard support layers), pillow-like (from support layers and soft cases), shell like (for insulating curved surfaces), L form (for insulating the corners), U profile form (for insulating the pillars), complex form profiles or even pre-made walls, reducing the thermal bridges to the maximum. By choosing the right material for the frames and the exterior support layers (protective layers, 4c), as well as the cases (5c), the final product can be used in the most difficult environmental conditions, and by applying an extra processing step, it can become reflecting, decorated, enamel, faience, fit with fixing elements, so that it eliminates part of the operations executed in the field. Thermo insulating plates with very smooth main surface and having nut-feder coupling profiles can be also obtained, so that by coupling several plates like this one can obtain perfectly plane surfaces (ideal for building thermo barriers inside the construction elements) that need a reduced number of fixing points, which are thermal bridges.

For insulating large plane surfaces with as few thermo bridges as possible, if no special impermeability conditions are required or if a “wall breathing” is wanted, open plates can be produced by framing, having fragmented frames and thus having only two full side walls (6b) or no full side wall if the frames are replaced by perimeter spacing elements (6d) rigged up on stressing bars (6e), going to the extreme where only corner spacing elements are used (6c) thus a minimum bridge number. Plates' stiffness is given by the protective plates (6a, 6a′; ex. PET with strengthening ribs). This type of plates allows a higher processing degree in the assembly field, allowing the cut close to the spacing elements. For insulating the respective surface, in case the used material needs such a protection measure, one can use along the perimeter plates having only the needed walls for completing the contour, while in the center region the plates used are as open as possible. Smoothing the final surface can be done by putting in joints of the spaces between protective plates (6E) or by applying the protective layer of a thermos barrier.

As well, building open walls plates allows air to be completely removed among support layers in the fabrication process, replaced with another thermo insulating gas and soldering the open wall or the piece of missing wall in a pressurizing chamber (6D.f).
building thermo-insulations on the assembly field, especially for large or complex shaped surfaces, by assembling the frames, spacing elements and support layers on the field. All the procedures used when producing multi-layered materials are allowed, the role of the protective plates or of the case being played by the wall or surface to be insulated, the wall or protective plate that are assembled after the insulation, and by pieces of wall and ceiling bordering the respective surface.
producing bearing and decorative construction materials with insulating properties using the previously described encasing procedure but using cases with thicker walls for static load bearing, with the possibility to use some additional spacing elements for bearing this load, or using the framing procedure with thicker base layers (given by the thickness of frames and spacing elements that are bearing the static load, or by the type of raw materials used). The support layers that are also bearing static loads, distributing them via spacing elements with the right dimensions will have the thickness on the limit of the mechanical resistance. This way one can obtain bricks of burned clay, concrete, concrete with polymers, BCA, PVC, synthetic resin or other materials (low permeability materials are needed to build thermos or vacuum barriers), as well as plating materials with a large number of layers with gas pellicle. Producing the exterior decorative skin, introducing nut-feder coupling elements, creating side empty spaces to fully hide the linkage substances, using sticky clays that can be applied in thin layers, fixing an elastic layer on the coupling surfaces, they all lead to perfectly smooth walls needed to build interior thermal barriers, to ready made walls or dismountable walls, to “porous walls”, etc.
producing window wall surfaces clear or less transparent using framing procedure, having thicker protective layers (10a; usually clear surfaces are made of float or low-E glass, while the less transparent ones are made of colored glass, polycarbonate, polyethylene, Plexiglas, etc) according to exterior forces, while the other support layers (10b) can be made of thin glass (that can be armed with fibers or butyral polyvinyl), polycarbonate, polyethylene, or any other transparent enough material. When producing frames, sashes, door casts, large air empty spaces will be replaced by classic thermo insulating materials or one of the new insulating materials described (10d), or by active barriers, and the interior walls will be reflecting walls (10c). For having a good sealing, this invention is proposing the usage of double walls gasket (10f) made of rubber or gonflable elastomers using a pressurized fluid.
producing “porous walls” for heating the fresh air introduced in the building, as well as recovering the heat contained from the evicted air (in the summer for cooling the air and recovering the wasted coolness from the air), recommended to be used especially if the building thermo insulation is done with impermeable materials or with vacuum barriers. These walls are to be used inside some of the exterior walls or parts of the roof (“porous roof”), made of successive layers of thereto insulating thin plates (11a) with small distances among them, or of bricks with air spaces especially produced for this purpose (11C,D), thus building an air-wall heat exchanger. Fixing the plates is done such as a continuous channel is created, preferably with horizontal air circulation, winding (but with straight segments when a resistance element, an insulating layer or a gas barrier is met) from a suction (11b) or an exhaustion (11c) point as needed, from inside the building to the exterior (11A,C). The depressurizing produced by the air blower and the channel sizes are computed so that air moving speed is low, facilitating an efficient heat exchange between air and the successive material layers. The efficiency of the heat exchanger, as well as the quality of the obtained insulation, are increasing with the number of layers, on behalf of the exhausted air volume. If the same part of the wall is to be used for both fresh air suction and used air exhaustion, the channel will be split using a separating diaphragm. The separating diaphragms can be placed so that two parallel channels are created (11B) realizing an air-air heat exchanger in counter-current. Another possibility is to have two joint channels, with segments of one interweaving segments of the second, direction of the two air currents being perpendicular (11D). The ideal placing for such a heat exchanger is behind a thermo bridge, or close to a window wall surface with which a beneficial heat exchange can be realized (forcing the air sucked or exhausted via a porous wall to pass at the right moment between two window sheets, thus recovering part of the heat that otherwise would be lost via the window; 10e).
producing clothes, thermo insulating bonnets, special equipments (specialized articles for sport men, for air flight men, mountain climbers, astronauts, divers, etc), via one of the described procedures, the most fit being the framing one where the support layers are soft materials made of cloth, impregnated impermeable cloth, polyacrylates synthetic materials, with small or close to zero permeability coefficient, preferable with some elasticity, base layers being thin foils of air, carbon dioxide or any other gas with low thermo conductivity coefficient non-toxic, non-aggressive and non-inflammable (using one or more saturated thermos sheets in successive layers, with the vaporization temperature close to 0 degrees Celsius leads, by gas evaporation in the active periods, to heat accumulation between layers loosing it via condensing in the non-active periods), and the protective layers being any material described in the current technical level. Support layers are made with distancing protuberance in order to achieve an optimum thickness of the gas pellicle. The fabrication process for this types of articles are the classical ones, but one must take into account that if the base layer is different than the air, coupling different components has to be done via soldering or the surface needs to be treated for impermeability after sewing. If it's acceptable to have a slight gas circulation between different interior layers, the exterior impermeability has to be perfect. Soldering and sewing has to be made such that the layers are pressurizing each other for keeping a constant gas film thickness during the usage. Filling valves have to be easy accessible for possible later interventions. Some of the gas layers can be thermos barriers or active barriers (by using an electric resistance linked to a small battery).
producing thermo insulating materials and bearing elements with additional thermo insulating properties, by changing some of the current technologies:
   filling in the vertical holes of the classic bricks with classic thermo-insulating materials or with new materials produced as per the procedures described in the current invention (12a), filling in the large air spaces from other construction materials or from the thermo insulating window frames (10d) etc.
   producing wool glass pillows, from mineral wool, basalt, wadding linen, in a gas environment with lower conductivity than the air and introducing them in an impermeable wall case, hard or reshaping.
   producing wool glass pillows by overlapping very thin tight fiber-network cloth layers, having on one or on both sides the fibers density computed so that overlapping those support layers the distance between them becomes close to the optimal one
   replacing the spherical small empty spaces from the materials obtained by bubble gas expansion in a liquid or viscous mass with lenticular shaped spaces. This change can be made if the intensity of the expansion process is higher (leading to a higher dimension of the gas bubbles), if the pressure is lower than the atmospheric one and the process is followed by another one, of substance compression (or by compression of some bubbles individually obtained and introduced in a die) in the technologic process phase when the base substance has the appropriate degree of ductility and distortion keeping. The compression leads to the collapsing of the spherical spaces, the increasing of their inner pressure and continues until the pressure becomes equal to the atmospheric one, keeping this configuration by solidification.

Thermos barriers contain a gas layer (possibly divided by several screens) between two layers with reflection properties. When producing thermo insulating materials, due to a reduced thickness of the base layers, the temperature differences that appear between them are very small and the heat quantity transmitted via thermo radiation (dependant on this temperature difference and the absolute value of the temperature) is negligible. Things are completely different if the support layers are transparent for these radiations, if they are just a few and/or the base layer thickness is big (due to mechanical resistance or any other reasons), if they are placed in the exterior or in it's immediate proximity, if the base layer is vacuum, or if the insulated material has a high absolute temperature. In these cases the support layers used have to have high reflection coefficient for these radiations. Using support layers transparent for thermo radiations, together with using enough layers with reflection properties when producing multilayered barriers leads to obtaining superior thermo resistance.

The thermos bather is made of a single base layer (13a), two support layers with reflection properties (13 b; protective layers) and a frame (13 c) and/or spacing elements (13d). It has very good thermo insulating properties, especially when in direct contact with the insulated object, with the heat source or with the exterior environment and can be used for:
producing thermos sheets and plates (one layer of air or another thermo insulating gas with the thickness higher or equal to the optimal one, closed between two layers with reflection properties and one frame) with a dimension range as large as possible, in combined usage with classical thermo insulating materials or new materials described in this invention, for building thermos barriers between two layers of a wall and for building active barriers together with a heat classic exchanger, classic or as per described in this invention.
producing saturated thermos sheets: thermos sheets in which a small quantity of liquid and saturated vapors of Freon or another gas with vaporizing temperature under normal pressure is between −25-+25 Celsius degrees is introduced. Using those sheets for creating thermos barriers inside a wall, when the working temperature is close to the vaporizing point, an inertial element is produced, leading to slowing down the heat exchange in both ways via vaporizing and condensation of the inner gas.
producing thermo insulating materials according to the current technical level or according to this invention (13A), and adding on one or both exterior surfaces a thermos barrier, and when needed also reflecting their exterior surfaces (13e). In those thermos layers one can introduce a thermo insulating gas at atmospheric pressure. Both thermos layers can be multiplied by introducing several layers with reflection properties (screens; 13f), especially for insulating very hot surfaces.
insulating the pipes (13B), which because of their shape are fit for using vacuum and where the pipe is playing the role of interior protective layer, while the exterior layer is made of metal, PVC, polyethylene, polyesters armed with glass fiber or other materials. One can produce a large variety of pipe sizes and adjacent fittings, pre-insulated, featured with an easy coupling system (for ex. with joints 13C with stuffing 13h).
for the insulations built on the assembly field, by applying a layer with reflection properties on the surface to be insulated, spacing materials on top, then applying one or more sheets with reflection properties and in the end the insulating material (13D: radiant floor). If one introduces valves in the spacing element thickness or in the insulating material (13g), the air can be eliminated or replaced with a different gas.
for reducing heat losses from the rooms heated via heat exchangers placed on the exterior walls, by covering the respective part of the wall and the back surface of the heat exchanger with a sheet with reflecting properties.
for insulating technological devices, tanks, reactors, pipes of any installation where thermal processes take place, burning point and walls of the boilers, furnaces (including the rotative ones), etc.
insulating devices and equipments with intermittent usage or window walled ones with intermittent exposure, using thermos barriers with folding exterior protective layer.
inside the construction elements, whenever the conditions are favorable to apply such procedures (multilayered walls, between any two successive layers)
improving the insulating procedures form the current technical level, by applying the insulations using spacing elements that create a thermos layer between the insulating material and the insulated surface (13D).

Vacuum barriers are thermos barriers that have advanced vacuum as base layer. For this type of thermal barriers all the forms of heat transmissions are reduced to the maximum, their efficiency being above the other types of barriers, but producing them is also much more difficult from technical point of view, due to large surfaces where the atmospheric pressure is acting. Most fit for applying these barriers are the curved surfaces, where directing the pressurizing forces to a reduced number of frames and spacing elements is easy to realize. For the plain surfaces, one of the following methods can be applied:
distributing the pressure from the main surfaces towards a perimeter frame as narrow as possible and/or a large enough number of spacing elements with the contact surface close to a point (14A). In order to reduce to the maximum the thermal bridges created this way the materials used for the frames and the spacing materials have to have a high resistance to compression and a small thermal conductivity coefficient: glass fibers, carbon fibers, graphite, PVC, polyethylene, Bakelite, hard plastic, hard ambrosin, sintered materials, composite materials, etc.
dividing the exterior pressure among several parallel successive layers, with the pressure in decreasing steps, made of elements of curved surfaces, with counter arrow, maybe linked into a honey comb type of structure (14B), the pressure steps being obtained with independent valves in each of the layers, with one way valve clack placed between layers, or if the number of layers is very large, it is obtained via channels with very small section that are linking successive layers
dividing the exterior pressure among several parallel successive layers linked via one way valves that are opening on a certain pressure level (14C), or via relatively long channels with very small section built in the frames where an important pressure drop is produced (6C; multilayered barriers with central vacuum). Vacuum is created in the central layers by extracting the air from it, while in the adjacent layers a pressure equal to the valve opening pressure (or equal to the pressure drop on the link channel) is created, the pressure progressively increasing in steps, towards exterior, until reaching the atmospheric pressure. If one of the protective surfaces has the right dimensions (or if on the other side of the wall to which it is attached there is another vacuum barrier), it will directly border the vacuum layer and the spacing elements and/or the intermediate corresponding layers can disappear.

The materials used for creating the vacuum barriers have to be degassed before usage, or treated with lacquer or paint for impermeability. The most efficient method, especially applicable for multi-layered barriers is the “supervised” vacuum method: keeping all the time a vacuum pomp able to intervene (capable to produce a pressure of min. 0.1-1 Pa). This one can be continuously in function on a constant pre-defined debit or intermittent for maintaining the pressure inside the central bather between defined min and max limits. Using this one can also obtain:
reversing the gas that entered the central layer and using its heat
exchanging air with the exterior, similar with the porous walls
building variable thermal resistance by introducing normal pressurized gas in the central layer.

The vacuum thermal barrier is one of the main elements of heat loss procedures applied in constructions and industry installations, according to this invention. If one supra-structure element of a construction or one component of a technological installation has minimum plain properties, it can be used as protective layer for a thermos layer. If it also has the minimum mechanical resistance needed the most efficient thermos layer can be used: the advanced vacuum one with several screens.

The vacuum barriers can be successfully used for:
insulating pipes (large variation of pre-insulated pipes and fittings can be produced, made of steel, iron cast, other metals, high density polyethylene, PVC, glass fiber armed polyesters, etc and having a fast coupling system (13C), technological pipes, tanks (especially the spherical and cylindrical ones), heat accumulators, furnaces (especially the rotative ones), boilers, technological installations devices where thermal processes take place, etc. In these cases it is useful to link thermos successive layers via by-pass pipes (13i), thus realizing a “supervised” vacuum. This bypassing can be also useful in the case of sezonality usage of the pipes: transporting hot thermal agent in the winter assuring a closed circuit (on the path: consumer—pipe interior—distributor—double wall—consumer) where the cooling of a fridge agent can be made giving away the heat to the environment where the pipe is placed. The procedure can be extended to any type of pipe (sewing, or pluvial, for gas or industrial fluids transportation) berried deep enough and not affected by the temperature change, whose surface can be used by the users in the area crossed by the pipe for capturing the soil heat or for cooling a thermal agent.
building supra-structure elements (14A) pillars, columns, headboards, belts, bearing walls, lintels, timber support elements, ceilings, etc) made of metal, concrete, concrete with polymers, burned clay, layered wood, PVC, synthetic ambrosin, composite materials or any other materials that are successfully combining resistance properties with thermal properties and that contain one or more simple or multi screen vacuum barriers. The barriers are realized by separately producing the component materials and their proper coupling, and for the elements made by casting they are realized by introducing the protective layers into the casting shape. The vacuum bathers are made so that the vacuuming valves and the one way clack valves remain accessible so that the infiltrated air can evacuated at any moment and to be used for possible repairing (one valve block is created near the bather). A vacuum pomp in the installation allows replacing the air in the intermediate layers with another gas with superior thermo insulating properties (the first vacuuming operation will collect the supplementary gas quantity and afterwards the infiltrated gas is returned into the atmospheric pressurized layer). If the stability needs imposed by the resistance computations are requesting, one can introduce linkage elements between the two protective layers of the thermos layer: for walls—double bricks embedded in both semi-walls, for metallic pillars—welded plates and for armed concrete—saddles, preferably non metallic, common for the two semi elements.
realizing the thermal bather between the interior and the exterior structure, in the case of total tubing
realizing special equipments (for air pilots, astronauts, divers, and firemen) made of subassemblies with vacuum barriers, linked in the joint areas by multilayered flexible materials.

Thermal barriers with variable resistance. It often happens for one to need different thermal insulation depending on a given schedule or stage of a process: window wall surfaces of the exterior walls in any building, important heat loss generators via conduction and especially radiation, should be screened during the night or when leaving the room; same for the displayable fridges and freezers with window wall doors when closing the store; a stationary vehicle in open space is loosing fast the interior climate conditions; technical devices where successive thermal processes with heat and coolness generation should have different resistances in different phases of the technologic process; a very well insulated device requires a lot of time for cooling in case an intervention is needed; etc. Solving all those situations requires having variable thermal resistance, which can be achieved via thermos or vacuum barriers with a series of construction particularities that allows the replacement a thermo insulating component with a thermo conductive one. They are used for:
screening a window wall surface using bedded window blinds (10g), vertical or horizontal, made of a material, preferable insulating, having one or both surfaces with reflection properties placed inside, outside or between two window sheets. During the day the blades are positioned so that they allow the light in, but on a manual action or one command coming from a presence detector and exterior light detector a simple mechanism is rotating the blades to produce a thermo reflecting screen.
the lamellar system can be replaced with another system, used in the current technical phase, made of rolled roller blinds placed in a box close to the window wall surface, that are rolling on a manual or automated action. The news proposed in this invention comes from: using thermo-insulating roller blinds (preferably made of a multi-layered barrier, with thermos barriers on both sides) with one or both sides with reflection properties; rolling the sides of the roller blind is made inside channels built in the window frame (10h), that using simple or air filled stuffing (10i) are sealing the film gas layer (or the 2 layers if it is placed between two windows); the gas between windows can be a powerful thermo insulating one); the rolling/de-rolling command can be automated, upon sunset, or when leaving the room. The same procedure can be applied for screening vehicles or devices.
for device screening: in case of an opaque surface, if this one has reflecting properties, by rolling the roller blind a thermos layer is created; one box with rolling/de-rolling system is used for each face of the device, or in case of complex surfaces they are decomposed in smaller fragments, attaching one box for each of them; the slot where the roller blind is extracted can have a shape to ensure folding/de-folding during rolling; the boxes can be detachable and are to be installed before starting the usage.
when screening an automobile there are two possible variants. In the simple one the component parts of the bonnet are placed in the detachable doubled bottom of the truck (15a), and they are manually extracted from the respective compartments, simply via pulling, through the slots (15e) which are involving the rolling of the axes; coupling of the different parts of the bonnet is done via simple elements like zipper, safety zipper (FIG. 15), buttons, clasps, etc, sometimes needing for complex forms of the bonnet a manual unfolding (for example for covering the sides of the car the bonnet has a rectangular form with two trapezoidal wings 15c in the inferior part, folded and fixed with clasps to the central part 15b); the inferior end of those two bonnet fragments can be fixed with hocks or the inferior margins can contain a metallic cable with a mechanism for attaching it to the neighboring bonnet piece (15A); refolding the bonnet is done using the springs placed on the rolling axes, manually doing the operation; the procedure can be used for thermo insulation or simply for protection against weather events, security breaks, dust or accidental scratching, etc.

In a more advanced version there are rails with one or two guiding channels placed on the body of the car, corresponding to the number of the driven rolls (15B). They can be visible or hidden in the resistance structure. Materials used for building the bonnet are harder, even with metallic insertions. The free margin of the bonnet has a flexible bar or a cable. When ending a ride it can be left free, can be ensured with small hocks to the rings placed in the inferior side of the care, or can go in a slot specially created for this purpose. The side margins have guiding rolls moving through the guiding channels 15k. Each piece of the bonnet is rolled/de-rolled using pulling cables 16j fixed in the guiding channel, which are rolling/de-rolling on manually actionable rolls via strings or preferably using small electric engines. Stop of the engines is guided by path limiters. Continuity of the bonnet is ensured via the rails with two rolling channels, no other coupling elements being needed. Entire system can be remotely controlled and can have security elements.
fast cooling of some devices with intermittent usage who's insulation was realized via a vacuum barrier is done by replacing the thermo insulating gas or vacuum with air (the valve block and the vacuum pomp being permanently available), with a liquid with high conductivity, or with a thermal agent with forced circulation. As well, a heat accumulator insulated with a vacuum barrier, placed inside a room for cumulating heat in the sunny periods, can become a radiant heat generator in the shadowing periods, by temporary vacuum elimination.

Active Barriers are filmed layers, preferable thermos layers, where a positive or a negative heat source is placed. This one can heat (cool) a protective layer, one or more sides of the frame, one or more interior regions of the base layer, taking action on the superficial thermal transfer coefficient, on thermal fluxes and on thermal transfer coefficients. Assembling an active barrier involves the appearance of a radiation transfer for a part of the total heat quantity that otherwise would have been propagated by conduction. The reflection of a portion of this radiated heat is equivalent with introducing an additional thermal resistance. The most efficient active barrier is obtained using as a protective layer of a thermos layer (the warm surface) a heat exchanger with a reflecting surface, according to this invention. The other side of the exchanger, towards the interior of the building, is intimately covered by a heat accumulator mass (radiant layer: concrete, mortar, ceramics, gyps-carton, etc.) with the thickness increasing with the temperature of the exchanger, or is included in an absorbing thermos layer (an air layer bordered by this face of the exchanger and by the radiant plate, both being covered with a substance with high degree of thermal radiation absorption, being able to communicate with the inside of the room with holes placed in the inferior and the superior part of the plate, through which a normal or forced air circulation is produced). The cold surface of the active barrier can be a simple reflecting foil, a thermos foil, a saturated thermos foil or the reflecting surface of a heat economizer with fridge agent, or of a capturing element of a heat pomp. From the technical point of view it is recommended that a number as large as possible of these elements is manufactured in a single block, in specialized workshops. One can realize this way, for example, panels with large sizes, that contain the radiant plate—(absorbing thermos layer)—heat exchanger—reflecting thermos layer—semi-heat economizer (one or more)—(reflecting thermos layer)—multilayered semi-plate with or without vacuum, which simplifies very much the assembling procedures and is assuring a superior quality.

The place for placing the active barrier inside the wall thickness and the power of the heat source must be carefully chosen, as placing it too much to the exterior implies an insulating layer with smaller thickness and a higher energy use. Because of this it is good that the energy sources used for the intermediate bathers are residual sources and the thermal bather is doubled by a heat economizer. Judiciously distributing the thermal energy needed for heating the room between more active barriers placed successively in the thickness of the exterior wall, one can obtain important energy economies, amplified by the usage of cheap non-conventional energy sources, easy to be used because the temperature at which the active barriers are working is decreasing from inside towards the exterior of the wall.

In case of a building the active bathers can be:
Intermediate, placed in the interior of an exterior wall, especially for improving the thermal resistance of the wall
Interior, whose warm surface is a radiant wall, a floor or a radiant ceiling of a room with which it realizes heat exchange especially by radiation. The favorable effect of transmitting the heat through radiation and the favorable effect (especially when the exterior temperature is varying around the adjusted temperature) of heat accumulation are added to the extra thermal resistance obtained.
Exterior, constructively identical with the interior ones, separated by the exterior environment with an accumulating plate. They can be used in the winter for capturing the solar energy and for transmitting it towards interior through ventilation or through heat economizers with fridge agent, and in the summer for eliminating the heat in the climate control systems.
Solar, separated by the exterior environment through a plate transparent to solar radiations but absorbing for infra red radiations, being themselves heat exchangers due to the produced green house effect. Constructively they are made of a transparent plate (glass, methacrylate, polycarbonate, polyethylene) (18a) placed on a portion of a wall or a terrace (roof framing) (18b), bordered by pillars and dashes (18c), forming modules of different sizes that can cover an entire front or a roof. Compared to a solar panel the insulating layer is missing, its place being taken by a heat economizer or by the vaporizer of a heat pomp. The solar heat can be taken in a classical way: by the absorbing wall, by an absorbing panel in the form of a plate, by a panel with direct or indirect warming tubes, or according to this invention: a semi heat economizer with fridge agent, a heat exchanger with air, water or fridge agent, solar tubes or lamellas, the vaporizer of a heat pomp.

The active barriers are used for:
reducing the heat losses by introducing in the exterior walls (especially in the area of porous walls) of active barriers with zonal modified characteristics (using small power sources) or on the entire surface of the protective layer from the interior of the room (using residual heat sources: phreatic water or from the bottom of a river or a lake, the drinking water on the path from branch terminal towards consumer, the residual domestic water after a primary treatment, the warm evicted air or the fresh one, a thermal agent heated or chilled by a heat pomp or by the electrical or thermal energy produced by solar panels, etc)
placing performing climate-control systems that are made of:
   radiant elements (exterior walls, floors, ceilings, other interior elements that are incorporating a positive or negative heat source or are separated by it through an absorbing thermos) that are the warm surface of an active thermal barrier
   heat economizers that are the warm surface of the next active barrier
   intermediate active barriers based on residual sources
   exterior active barrier in which one can place, depending on the case, the exterior heat exchanger of a classic climate control system or one according to this invention, a heating source with residual energy for slowing the heat transfer from the interior, an absorbing panel, the capturing element of a heat pomp
   solar barriers with classical panels or according to this invention
   heat accumulators having as insulation multilayered barriers or barriers with vacuum
   heat capturing with pipes or plates, placed in the ground or in the foundation
   fridge agent tanks with the role of heat exchanger with the exterior environment, placed in different construction elements: pillars, columns, corbels, etc

The construction procedure via total outer covering. The purpose of this procedure is to diminish to the maximum the effect of thermal bridges, ensuring this way that the energy produced by positive or negative heat sources is kept inside the building. The procedure is based on building two supra-structure systems on the same infrastructure: an interior one, classic, for giving the space functionality: private, public, commercial or industrial and another one, exterior, built at some distance vs. the first one, having as few common elements as possible, for supporting the insulating elements, the exterior decorative elements, the curtain walls, as well as the exterior elements of ventilation and climate control installations, the roof or facet solar panels. In the space between the two supra-structures a multi-layered barrier is assembled, thick enough and bordered on one or both faces by a thermos barrier or even better by a vacuum barrier. The procedure doesn't imply special design or construction problems, but the effect of the pressures that appear by creating the vacuum barrier has to be taken into account. This way the entire interior space is transformed into a heat accumulator. From the thermal point of view the common elements of the two supra-structures have to have an individual thermal barrier, and the pipes and the linkage tubes between installation elements placed in different structures have to be additionally insulated. Both suprastructures can contain one or more active barriers: the interior one behind the radiant elements, heat economizers, corrective sources, etc and the exterior one attached to the exterior heat exchangers of the climate control installation, to the capturing elements of the heat pomp or to the solar panels, etc.

Because of the small heat losses such a construction can insure the entire needed heat from air and ground through the heat pomp and from the sun through the solar panels placed on the roof and on the facets, and in case of large size buildings it can even produce supplementary energy via solar energy conversion. In FIGS. 1, 2 and 3 different building structures are presented, representing a supra-structure made of concrete pillars (1a, 2a) or metallic pillars (3a), brick walls (1c) with empty spaces for hiding the pillars (17C), concrete walls (2c) with vacuum thermos (14A) or of metal table (3c). In this supra-structure there are active barriers incorporated (1g, 2g, 3g) made from thermos strips and heat exchangers with plates (1e, 2e, 3e), covering a big part of the interior surface of the wall and that can have among their components elements from the building structure: thin table sheets (1f), thicker sheets (3c), the concrete wall and PVC foils (2f), the radiant surface attached to the interior plate made of gyps-carton (1d) BCA (2d), polyurethane (3d). Between the exchanger's plates can circulate air, water, another fluid, and fridge agents in the form of saturated gas. The exterior supra-structure is sustained by metallic pillars (1b, 3b) or concrete pillars (2b), concrete or brick walls, metal plates (2j) and is made of a pillars and dashes network that is supporting the insulation of multilayered plates with marginal vacuum (semi plates; 1h, 2h) or central vacuum (3h), as well the solar bathers bordered by an absorbing wall (1j, 2j, 3j) and one (1k, 3k) or two (2k) transparent sheets. Inside the solar barrier there are solar panels (1m, 2m), solar tubes (3o) with adjustable orientation around the axis, with the solar lamellas placed in a plane (1l) or in two planes (2l), placed on the roof inclined, on the horizontal north and south facets, oriented towards sun, respectively towards ground, and vertical oriented on the eastern and western facets (2l). The captured heat is used for warming the spaces and form producing hot domestic water, the extra quantity being stored in the accumulators (21a) placed in the ground, in the interior or exterior of the building. The needed heat can also come from the phreatic water, from the bottom of a river, from the ground from a 1-2 m depth through a pipe network through which a fridge agent is circulating, from air or solar barriers, being captured using heat pomp or soil-air heat economizer (21c). This construction procedure also requires a series of new construction materials, with different properties vs. the ones currently used, as well as a new way of building the installations as already shown. Following, we will give some examples of obtaining these materials and installations.

Procedures for producing multi-layered materials. The first operation to be run after choosing the materials that are supposed to be used for building support and base layers is determining the optimal thickness of the base layer. The thickness is different form one gas to another and also depends on the layer orientation vs. temperature gradient, on the nature reflexivity degree of the support layers and on the temperature. For its determination, when the base layer is the air, one must make a number of probe plates using one of the procedures described below. All the plates will be made on the dimensions imposed by the device for thermal conductivity measurement and with the size of the support layers as small as allowed by the building process. The frames and the spacers are made of a material that allows obtaining small thickness, even if in the fabrication process is expected for another material to be used and even if in the fabrication process will be a different number of spacers or they will not be used at all. All the plates will be identical from the structure and dimensions point of view, the only difference being the base layers thickness (whole multiple of the smaller thickness of a support layer), obtained by different thickness of the frames and spacers. By successive measures of the thermal conductivity coefficient for all plates, one will notice that this one will progressively decrease until reaching a minimum corresponding to the optimal thickness, and then, once the convection appears, the coefficient is starting to increase. The operations can be repeated with reflective support layers. When using a different gas, the operations are done by sealing the probe plate.

A thermo insulating material built via this procedure contains the working gas as pellicles, as ordered networks or unordered regions. It is made of two main components:
support layer (4a, 5a) made of a material, ideally with good thermo insulating properties, with the lowest thickness allowed by the producing technique and the mechanical forces as well as by the thermal, chemical and aging factors to which it is exposed. The main role of this layer in this procedure is to prevent the convective gas circulation in the base layer. If because of the manufacturing procedure there are holes in the support layer (or if a fabric is used for its manufacturing) their number, size and density shouldn't significantly influence the convective circulation. One can use hard materials in the form of plates, as well as soft materials in the form of leaves or sheets made of a single element (6a) or separate segments (6f). Two or more materials can be used for the support layers when manufacturing a thermo insulating material according to this procedure, that are alternating where needed (for e.g. for increasing the mechanical resistance of the assembly, for creating vapor barriers, for diffusion layers or for introducing reflective layers). As well, when the support layers are built from close to air-proof materials (metals, polythene, etc) they can be opened (by punching) in order to allow “wall breathing” (6j).
base layer (4b, 5b) usually made of thermo insulating gas in a continuous or fragmented pellicle with optimal thickness. Inside the gas pellicle one can introduce spacers in order to maintain a constant thickness for the pellicle if the support layer is shapeable. The gas pellicle can be also interrupted from place to place with linear horizontal spacers if the material is used for insulating vertical surfaces. For very soft support layers one can use nets made of wires with the same thickness as the gas pellicle and with the width as small as possible (there can be cylindrical wired with the same diameter as the pellicle thickness as well) having the meshes with the maximum size allowed by the base layer degree of distortion. These spacers can be made by processing one side of the support layer as long as this one is a good insulator or they can be made independently from materials with high thermal resistance and with contact surfaces with the support layer as small as possible.

The proposed procedure allows the usage of air, vacuum air or any other gas in manufacturing these materials (Freon, xenon, krypton, chlorine, methane per chloride CCl4, chloroform, acetone, acetylene, ethyl acetate C4H8O2, methyl acetate C2H6O2, carbonic anhydride CO2, sulphurous anhydride SO2, benzene, butane, isobutene, hexane, ethyl bromide C2H5Br, methyl bromide CH3Br, carbon sulphate CS2, ethyl chlorine C2H5Cl, methyl chlorine CH3Cl, methylene chlorine CH2Cl, ethyl iodide C2H5I, methyl iodide CH3I, etc) with a thermal conductivity lower than the air on atmospheric pressure or lower.

Combining the two types of layers can be done via more methods:

A. By framing (FIG. 4), executing the following operations:
the protective support layers are built first (4c; the first and the last support layers) from materials that can differ completely vs. the ones used for the other layers, and different one from another, each of them having the most suitable properties for the purpose and environment where it will be used, by processing operations for smoothing, for gaining reflective properties, for making it impermeable or fire proofed, for impregnation, decoration, glazing, painting, and for building attaching elements, etc.
the reflective support layers are built from very thin plates made of a metal with high coefficient for thermal radiation coefficient or from another material on which one can apply a reflecting layer with micron size by soldering, by pulverization, by painting, via electrolysis.
building the support layers with special destinations: diffusion layers, vapor barriers, layers that are taking the static pressure, etc
building the plates, leaves or sheets of the support layers (4a) with the desired size. For the products having insulating usage only, raw materials that can be laminated in thin sheets are preferred: invention, celluloid, metals, glass, mica, rubber, polyethylene, PVC, polyurethane, synthetic resin, dense clothes of silk or synthetic wires, or a mix of resins and glass wires, etc. For the products taking static pressure hard materials are used: metals, argyle, concrete, eternith, graphite, carbon fibers, polycarbonates, tabular alumina, hard resins, composites, sintered materials, etc, in the same time applying different procedure for trussing of frame. For the materials where no other materials more fit were found for frames and spacers and where the fabrication technology allows it (metals, products obtained by plastic reshaping, agglomeration), the frames and the spacers network is created inside the support layer, by press forming or punching (6A). For the products that will be subject to air extraction through valves the holes for air circulation are created such that the gas path is the longest possible. The holes for the screws have to be created for the products to be fixed via constriction.
building the frames. For the products with thermo insulating purpose only, their thickness is determined by the base layer thickness, and the width is determined by the assembly conditions, taking into account the fact that the frames are thermal bridges for the insulation assembly. For the products with lifting role, the frames are sized taking first into account the carried weights. When using vacuum into the central layer and stepped pressure in the following layers, the channels for creating the pressure fall are created inside the frames and support layers by punching, press forming, by cutting (6C) or by adding a cord with the same diameter as the base layer on the support layer on which the frame is applied (6H).
the frames are applied on the first protective layer and on each support layer (FIGS. 4, 6). The adherence to the support layer is made through liquid or pasty adhesives with small thermal conductivity coefficient. If the assembly environment allows, the frames will be entirely made of such binding materials (silicon, polyurethane foam, elastomers). Another joining possibility is by using frames made of materials elastic enough so that if the protective plates are tightened using non metallic screws or rivets the needed sealing is ensured without using other adhesives. If the support layer is reshapable (being very thin), some technologies for stretching are needed in order to reduce to the maximum the number of spacers:
   frames are applied on the well stretched support layer using fast welding methods (thermal, electric, chemical, etc)
   the frames and the support layers are successively applied by fast welding. In this case the support layers can be used even without sectioning them by their continuous rolling from a cylinder having a rotation and a translation movement in the same time with a welding head (8a), alternatively passing the material on the exterior side of the frames (FIG. 8)
using frames (complete frames, with two flanks only or only corner spacers depending on the need to obtain a closed plate, two flanks open or fully open/introduced in a box) in who's corners small holes are created (FIGS. 6,8); the frames are applied adherent on the support layers; the tensioning bars (6e) are made of tough materials, thermo insulating, with a higher length than the final width of the thermo insulating plate; the bars are placed in holes made in the corners of the first protective layers (6a) if this one is made from a hard enough material, or in a fixing device; the frames and the support layers are successively applied on those bars (they can be cut through the same way as the frames or simply by introducing the bars in the holes made in the frames); tightening of the support layers is made by applying the second protective layer (6a′) on the tensioning bars; in the end the bars are cut and riveted (or they are completely removed after the adhesive is stiffened).
the spacers are made and then applied on the first protective layer and on each of the support layers (4e). For the products with thermo insulating purpose only the spacers are made from materials with the conductivity coefficient as low as possible, as small as possible, and are non-uniformly applied on the support layer (4e) with the density imposed by the capacity of deformation of the support (for example via pulverization). By blowing a mix of thermo insulating gas and a liquid thermo insulating substance (polyethylene, polyurethane, rubber, etc) into a stream of cold air via nozzles with a very small diameter some spheres are created, filled with the chosen gas, ideals to be used as spacers. It's preferable for the adhesives to be applied on the spacers instead of the support layer or for the spacers to have adhesive properties. If the adherence degree of the spacers is enough for those to be kept fixed by the force between the protective layers, one can give up using adhesives, improving the effect in the thermal conductivity coefficient of the assembly. The spacers in the form of wires or net are only used if a fragmentation of the gas film is needed. On contrary, for the bearing products the spacers have to be built from materials as resistant as possible at compression, with the sizes computed based on those forces, and they are applied in an ordered net, identical for all layers, (5e) so that the overlapping is perfect. There is also a frequent usage of linear (6h) or reticular (6i) spacers for taking the static load. Another option is for the static loads to be taken by cylindrical spacers or in a form of vertical plate (5g) or grill, placed between the protective plates or being part of one of those plates (5g). Around them, between the support layers, different spacers in a ring form (5h), cord form, respectively frame form are placed made of materials with superior thermal resistance, and the support layers are built with holes (5a′) or made of fragments (6f).
the first support layer is overlapped and stuck over the protective layer. Implicitly in this moment the pellicle base layer was introduced by closing a portion of the gas from the working environment: air at atmospheric pressure if the operation is done in normal environment, or the desired gas with the desired pressure if the operation happens in a closed space filled accordingly.
the operation is repeated for the computed number of support layers, then the second protective layers is stuck. The product obtained this way will usually have a higher thickness than the computed one because of the air layers formed between frames and the support layers, because adhesive tolerance and because of small form alterations for the used materials. The computed thickness will be obtained by tightening or by pressing (the adhesive being not yet completely dry).
the product thus obtained is processed depending on the environment and the conditions where it will be used. In this phase the protective surfaces can be treated, but usually only the side walls are treated and the overall treatment operations are applied: impermeability (by applying a thin continuous film of resin, polish, etc. or by tighten packaging of the entire product in a foil), creating in the frame width (if this didn't happen when building the frame) places for fixing elements, for valves, for one way clack valves, etc and the frames are finished in order to be easy usable
the qualitative tests are performed

In one version of this procedure the frames can only have two trapezoidal or rectangular flanks (6b), can only be frame fragments (6d), or only frames (6c). Respecting the succession of the operations this way one can obtain products with two open walls, with large sizes open or without walls if needed for atmospheric exchange in a pressurizing room, or for usage as such if the assembly conditions allow it, being recommended for porous walls.

For producing materials with bearing capacity (argil bricks, concrete, polymers, etc) it is possible to apply a better method: the frames (6g) together with linear (6h) or network (6i) spacers are made of a pasty material (argil, synthetic resins, plastic materials) in a single element, and the support layer is divided (6f) in an number of elements equal to the network eyes, having the surface a little larger than one eye. This allows that when the frames and spacers are overlapped in a pasty phase they come into close contact (6F) and by an easy pressing and a wet taping of the exterior walls they form a single block with superior mechanical properties. In each support layer fragment and in the protective layers some holes are punched for humidity eviction in the drying process.

If on the usage place one of the protective layers comes in direct contact with the atmosphere or with a hot surface, it's recommended that the near base layer is a thermos one.

B. By casing
building the cases, usually in a parallelepiped form, open (5c) with rectangular base, with sides of 20-200 cm and height of 1-10 cm. The base and cover (protective layers) thickness is as small as possible, still taking into account the forces they are exposed to, and the thickness of the side walls is a compromise between those forces and the fact that they are thermal bridges for the entire insulation. When choosing the material one must take into account several factors: the mechanical stress that will follow, using soft materials (polyethylene, impregnated carton, crib, impregnated cloth, natural or synthetic rubber, etc) or hard materials (metals, argil, concrete, eternith, graphite, carbonic fibers, polystyrene, polycarbonates, tabular alumina, hard resins, composites, sintered materials), sealing properties needed against humidity, permeability towards the gas used, permeability towards air (if a breathing wall is needed), usability properties. The exterior surfaces of those cases will be processed exactly like the protective layers in the framing procedure, in order to enrich them with additional properties and to make them easier to manipulate. Its preferable for the interior surfaces of the case to be lined with a thin layer of soft material (5A,k: mineral wadding), as the lack of frames makes the support layers to communicate between them leading to the appearance of a small convective peripheral current. The material for building the cover as well as the one for the bottom of the case can be different vs. the one used for the sides of the case. As well, all faces of the case including the cover can be made from a single plane piece, obtaining the case by bending it at 90 degrees along the separation lines. The most fit solution is chosen depending on the environment where the plate will be later used. There is a possibility to build cases lacking one or two of the side walls, in order to replace the working gas or to be used as such
building the plates (foils) of the support layer (5a) with the desired size, making and fixing the spacers on the bottom of the case and on each support layer (5e). These operations are also identical with the ones in the framing procedure.

If the support layers are sourced from waste materials, they can be used even if their size is not identical to the one of the case they will be introduced in. As a result one will obtain pellicle layers communicating among them in the marginal area, which doesn't diminish very much the performances of the assembly, the supplementary convection effect being compensated by the possibility to introduce in the case a gas with small conductivity coefficient and by the advantages given by the outside layer. On the edge, the support layer can be as fragmented as possible by using materials in the form of stripes, wood chips, boring dust, filament, flakes, granules, wadding, etc. or combinations of those. As well, small pieces of waste materials can b used as spacers between complete or fragmented support layers. The procedure allows thus using a large variation of waste materials.

In some situations the surfaces of the support layer are built with a degree of roughness, with small or punctiform protuberance, linear or reticular, having the role of spacers vs. the next layer or of fragmenting the gas pellicle.
introducing the support layers and the spacers (punctiform, linear or reticular) are introduced in cases and implicitly the base layers as well. The environment for this operation, until the sealing of the case, will be under control so that the humidity and purity conditions are respected.
if using soft support layers in the form of a continuous strip rolled on a cylinder and tensioning combs, the spacers can be completely eliminated (FIG. 9). The comb teeth, as many as the base layers, with the same thickness and with the distance between the axes double vs. the thickness, are introduced in muffs that can slide inside two pairs of supports, placed on a distance equal to the length of a support layer one vs. the other and having a vertical offset equal to the thickness of a tooth (or they can rotate in a plane perpendicular on the support). Initially these teeth are in the upside part of the supports, stopped by some blockers (or rotated, parallel with the long side of the plate). The first protective layer is placed on the work bench and the first tooth is freed (or rotated, parallel with the small side), tooth which will slide until touching the protective layer surface; here the end of the strip with support material is passed over the tooth and fixed by soldering from the margin of the protective layer; the cylinder with support strip is starting to roll, in the same time with moving towards the opposite side of the bench and it stops after passing the end of the protective plate; in this moment the corresponding tooth is freed, occupying its position on the first support layer; the succession of operations is repeated until reaching the final thickness; the side walls of the case are applied by soldering (preferably via thermal welding) fixing and if needed pre-tensioning the support layers; then the support strip will be sectioned, the cover attached, the combs are taken away by withdrawal or rotation of two supports, if needed the other two walls are fixed, then everything is finished and the quality checks are done
in most of the cases the content of the case will exceed its superior margin due to the loose positioning and a slight supra dimensioning of the spacers if made of soft materials. This is even desired, so that by a soft pressing the materials inside are immobilized and the support layers are smoothen. This pressing is made by placing the cover, if needed using a guiding device (5f) built so that the materials are placed in the predefined place.
the cover is soldered, using a proper adhesive
if needed, the air is removed from the case and replaced with the desired gas, until obtaining the desired pressure (or de-pressure).
if the conditions where the gas is used are requiring, the plate is dressed with a corresponding protective layer
the plate is finished and qualitatively checked

The variants described in the previous procedure are applicable in this one as well: using one element spacers (5g) for distributing the static loads from the exterior surfaces, building the case by suppressing one or two of the side walls until the gas is changed in the base layers or for using it as such, introducing reflecting support layers and marginal thermos layers, building the case or the linear spacers from a single piece or in a network form (5c′, 6m). Depending on the characteristics of the materials used for this variant, different technologies can be applied: casting the concrete or the argil in forms, the dust in dies being sintered, resin injection, putting elastomers or polyurethane foam in dies, casting followed by centrifugation in forms of the composite materials, etc. In this case the support layers are made of fragments and are overlapping, building by framing sub-assemblies with the size of a net eye and with the same thickness as the case (6r) that are introduced in these eyes. If the cast material has the appropriate consistency, these sub-assemblies can be fixed using some bars (6p) (that are also the evacuation holes for humidity), by the bottom of the cast form (6n), the material being cast between the walls of the form ant these subassemblies, incorporating the margins of the support layers.

The installations needed to produce the parts of these materials are usually installations for mechanical processing, for processing by plastic deformation, for sintered processing, etc. and for the final product, packing installations. For both methods, the packing operations can be executed in an open space, the air being the gas in the base layer, or in a closed space with controlled atmosphere, the gas in the base layer being the one available in this space. The insulating plates that have air as base layer are used as such, or are further processed by vacuuming or by replacing the air with a more thermo insulating gas.

When using for base layer a rarefied gas, the sizing of the frames and exterior support layers is done so that the plates are resistant to the pressure conditions.

For using as a base layer a different gas than the air with a smaller coefficient for thermal transmission and a different pressure, one of the following solutions can be used:
First the thermo insulating plates are produced having as base layer air at atmospheric pressure. Few more steps are added in their processing: the thickness of the frames and of the exterior support layers (for framing procedure) as well as of the case walls (for casing procedure) is realized with strengthening ribs, with a thickness high enough to support the later pressures; support spacers are built (if needed) that will be placed between the two exterior faces for uniform distribution of the pressures appeared on those surfaces; insulating circles will be built (if needed) and placed on those spacers between two support layers in order to diminish the effect of the convention phenomena (5B); inside the support layers holes are created for passage of those spacers; if a rigidity is needed between the side walls, one or two intermediate support layers with the right dimensions are created; holes are built inside the support layers with the diameter high enough to allow easy circulation of the gas during introduction—evacuation operations, but not too high to avoid the appearance of the convection phenomena, (fixing the support layers will be done so that between every two consecutive support layers the holes are on opposite sides); one or more valves are constrained in the frames thickness, through which a certain amount of air can be evicted, with the limit allowed by their mechanical resistance; holes are executed in the frames' thickness or in the walls of the cases for the operations of gas eviction—introduction if this is happening in the pressure room; the corks for closing these holes are made; the case is treated for becoming reflecting; the kits and foils are prepared for making the surfaces impermeable.
The operations of air replacement through the valves in the walls are executed, using simple physical procedures (for ex. Replacing the air with the liquid working gas, followed by an emptiness and a vaporizing operations), or in pressure chambers. Those are chambers with the walls thick enough to resist to the corresponding pressure difference, linked by pipes that are crossing the walls to a vacuuming installation and to another one for introducing the working gas in which there is an installation for closing and sealing of the valves and corks from the plate walls. In those chambers, the air is eliminated from the pressure chamber in the same time from all the plates from the room through the holes in the walls or through the cover, so without having any pressure difference between the interior and the exterior of the plates, then the desired gas is introduced, the holes and the covered are sealed (6D.f), the gas left is recovered and everything comes back to the initial environment taking out the modified plates and introducing a new set.
Producing the plates in an installation in a controlled environment (16A, B): a packing machine is installed in a pressure chamber (16a), fed via one or more pressure chambers (16b) with the elements composing the material, the finite products being taken through a different room, also a pressurized one (16c).

When building large sizes thermo insulating plates with vacuum, the high pressure on the side faces are taken by intermediate support layers, made of hard reflecting materials, and the pressure on the main sides are taken by spacers placed between the two plates. Another option is compartmenting the interior layer in several layers, having the pressure decreasing in steps form the exterior towards the interior where vacuum is reached. This can be achieved the same way as the vacuum barriers by:
valves towards exterior, placed in the walls of each layer
a single valve in the central layer and with string corks that are opening at a determined pressure, fixed between each pair of two consecutive layers. In this case the materials use are de-gazed and then treated for impermeability
a valve placed in the central layer (with a higher thickness and with reflecting sides) and by channels with very small section placed in the frames' thickness between neighboring base layers, where the pressure fall is enough in order for the left pressure to be supported by the material of support layer and by the frames (the case walls). In this case the frame of the central layer is made of fragments, so that when fixing an insulating layer made of such plates there is a communication among all central layers and a single vacuum pomp is needed. Also there is the possibility for this type of barrier to be made of semi-plates having only the components between a protective layer and a reflecting layer of the central layer. In the assembly face the surface to be insulated is insulated with those semi-plates and then using some frames the desired number of screens is mounted, then the vacuuming pipe and then the second half of the installation in placed: a plate with the same size on which semi-insulating plates were applied.

By the superior thermal properties and because of the simple procedure for manufacturing them, the thermo insulating materials produced via this procedure can replace the materials produced vs. the classical procedure in all areas where they are used: insulating the buildings, the containers, the devices and the equipments, etc from thermo-technique, frigo-technique, chemical industry, food industry, textile industry, the one of construction materials, etc.

Assembling procedures. Using the described procedures thermo insulating materials in form of plates or sheets are produced, with predefined size and form, that only in the case of some composing elements (and only if the base layer is air at atmospheric pressure) can be cut, and if the environmental conditions are requiring a re-sealing, this is pretty hard to be achieved. This is why it is advisable that the variation of sizes and forms is as large as possible in order to cover as many situations as possible, leaving the small surfaces to be covered with classic materials or by assembly in the field. As well, in order to reduce the thermal bridges, the preferable plates have the perimeter as big as possible. Also in order to reduce the thermal bridges and to obtain coupling properties, some plates are built with the increased side surface by bowing them with an angle of 45 degrees minimum (9A), by a sharp angle, by curved profiling (9B), by creating ditches and grooves (9C). These profiles are obtained in the framing procedure by assembling support layers with different sizes or by shifted soldering of the frames, while in the casing procedure by building cases in the respective forms. Those methods are trying to ease the assembly, make it in a continuous layer without holes and if possible without adhesives. The shape and size for these grooves is are designed so that the thermal bridge effect is reduced to the maximum. If after the assemblies there are still surfaces not insulated which can't be covered with the existent range of products, they will be insulated with classic materials. For insulating such surfaces, for insulating large surfaces with as few thermal bridges as possible, for creating thermos or vacuum barriers with a surface as large as possible, as well as for insulating surfaces with complex forms, one can use support layers with the spacers already attached, adhesives and materials for frames in a rolled state that can be cut and assembled on the field.

If the exterior layer of these materials is made of a material for which there is already an existent assembly technology with adhesives, there is no issue in applying it as generally the new product is lighter than the classic one. If the type of exterior skin requires an assembly technology using fixing elements like nails or screws, they can only be used as such for the materials that can be penetrated. Otherwise the holes for these elements have to be built from the manufacturing phase in the thickness of the material, the frames or by attaching fixing camps or ears. In these entire cases one must take into account that both the adhesive between the insulating plates and the fixing elements are thermal bridges that have to be reduced to the maximum. If the outside skin is not appropriate for these assembly procedures or if the minimization of thermal bridges is desired, new procedures can be applied. The assembly procedures proposed in this invention have the advantage of reducing to the maximum the possibility for the thermal bridges to appear and can be applied both to the materials described in this invention as well as to other materials. The thermo insulating materials being generally easy materials, few fixing points are enough.

1. The fixed points procedure:
there is a starting plate set, supported on the base of the wall on a support profile, or the starting plate set is fixed with adhesives and fixing elements
next plate sets are built interwove, with adhesives or using nut-feder fixing elements on the plates, until the first fixed point. This is an element identical with all the others, but having fixing elements: catching ears, clamps, screw holes, grooves for increasing adhesives adherence.
the process is continued until the end, passing all fixed points. The density and the position of the points is determined in the design phase, depending on the insulating plates weight and on the layers fixed on them.
if one wants to introduce a thermos layer or a gas thermal bridge, assembling the elements with fixed points is made with spacers or on an adhesive layer on the same thickness. The thermos barrier can be also introduced before the assembly of the insulation, on the surface to be insulated, by separately placing the components (if the base layer is with air), or form pre-made rolls. Also, the thermos layer can be from manufacturing on one or both surfaces of the insulating plates.
the resulting exterior surface can be assured with longitudinal and transversal profiles, definitively or temporarily until the assembly of the next layer, with a foil or a net that is tightly covering the entire surface.

2. The outer covering procedure, based on building step by step, around the building, a bar structure of cage type for supporting the insulation, having as few fixing elements as possible (as these are thermal bridges):
the starting points for the vertical pillars are fixed in the foundation: plates build in the concrete, bolts for catching the chord of the first section, etc. Number, size, shape and density of the pillars are depending on the total weight of the insulating layer and the next layers.
if this is designed, on the surface to be insulated one can apply reflecting and spacing elements as needed
the first chords of the pillars and the first linkage elements between pillars (preferably horizontal) are fixed, having stretching devices, their number being dependant on the plates dimension. The plates of insulating material are introduced between the wall of the building and this cage, and if the system was built as such, the elements of the cage will be hidden by the insulating plates. If there is another exterior layer also made by plates, the elements of the cage are designed for supporting them and the insulation is to be introduced between this layer and the wall. The procedure also allows the possibility to use active thermos barriers as per this invention.
the operations are continued step by step until the roof. During the work, if the walls are not all built in the same time, having additional temporary elements is needed, for supporting the cage on the building elements.
the cage can be closed on the top as well, depending on the type and later usage of the roof, the number of fixing elements on the building increasing this way.

The procedure allows an easy and efficient fixing of different insulation types, is extremely flexible allowing simultaneous execution of more types of operations, and for new buildings it allows eliminating the exterior scaffolding.

3. The frame procedure is applied especially for realizing thermos barriers and “supervised” vacuum barriers:
the block of valves and the junction to the vacuum pomp are placed, where needed
the reflecting layer or the thermos foils is placed in a continuous layer on the entire surface to be insulated
the first frame is placed along the perimeter of the surface. It can be continuous or built from more spacers, can be made of soft materials (in rolls) or hard ones (sticks, slats, etc.), depending if the barrier is a thermos or a vacuum one
the first support layer is placed, in a continuous layer, by assembling the component elements: simple sheets, (usually in rolls) or plates, depending if it is a simple support layer, the protective layer or one of the vacuum barrier screens.
the next frame, then the next support layer are placed, etc, and in the end the next layer that can be an insulating layer made of classic plates or as per described in this invention, can be a supra-structure element or an active barrier

Producing the bricks. As described, the invention in proposing a series of new procedures and materials for increasing the thermal transfer resistance for different types of bricks used in constructions. Additionally the invention is proposing a higher focus on building the exterior cover:
applying in a pasty state, before drying, an additional layer (if manufactured via framing procedure this will be the outside protective layer) with the same composition but with a higher degree of finishing, or with a different composition but compatible with the base one, one can obtain: bricks with a higher degree of smoothness of the surfaces needed for building high quality thermos layers or for which the plastering is not needed; decorative bricks recommended for exterior sides of the walls eliminating the usage of exterior scaffolds and the finishing work, polished bricks for usage in humid environments; glazed bricks, enameled or faience, for interior and exterior decorations, etc. Joining this type of bricks requires usage of binders that can be applies in thin layers.
by realizing horizontal and vertical emptiness with the right dimension and by cutting the dividing walls inside the bricks placed on the wall contour, (11 C, D) one can obtain bricks with porous walls.
realizing channels on the four side facets dimensioned so that by attaching or overlapping two bricks one can obtain alveolus where the binding material is introduced in a determined quantity so that this quantity is as large as possible but without over falls (17A). The surfaces through which the bricks are attached will have nut-feder type of attaching elements (FIGS. 12, 17e), so that the resulting surface is perfectly smooth. The assembling operations for this type of bricks can be very easy mechanized. For some bricks the alveolus can be built on the entire side surface, with large sizes, so that when building the wall by attaching and overlapping them, horizontal or vertical channels are built on the entire length of the wall (17C) where one can also introduce rigidity elements for increasing the wall resistance. Those channels can be also built by certain holes with the right dimensions in the bricks.
by building on one of the facets some punctiform, linear or reticular protuberances and creating a reflecting surface in order to achieve one of the protective layers of a thermos or a vacuum bather
if the bricks have channels on two sides and on the opposite sides grooves in opposite mirroring that are perfectly fit into these channels, the bricks can be assembled so that the resulting surface is perfectly smooth. The used binder has to be applicable in a thin, resistant layer. If instead of a binder on the attaching surfaces one is placing a layer of elastomers (17a) or another material with the needed elasticity degree, this can also lead to obtaining very smooth walls, built starting from two continuous rails (17b) with the same section as the one of the attaching channels (one placed on the floor, the other on a side wall), that perfectly fit in the first row and in the first column of bricks and semi-bricks. The last row and the last column are closed with “U” shaped elements (17c), so that the surfaces are plane in the terminal areas as well. Stabilizing the wall built this way is realized by filling in the terminal holes, by casting the marginal concrete elements in predefined shapes. If the wall is built on a prefabricated structure, the terminal holes can be filled with high expandable foam (17d) that is finished after drying. As well, the remaining emptiness can be filled with an air pillow. In this way one can obtain walls that can be easily disassembled and with full brick recovery. Both resulting surfaces can be used for applying a thermos layer.

Heat exchangers used in building the active barriers have to have the following constructive conditions:
having a surface as large as possible (covering as much as possible from the wall surface by placing a single element or by attaching several standard type elements)
Having the thickness as small as possible
The warm surface (inside the room) having a heat exchange with the radiant surface as efficient as possible by directly embedding it into a material with heat accumulator properties (carton, wood, PAL, gypsum carton, glass, bricks, concrete, blanket, Estrich, cased ceiling), or by using a layer made of air or another thermo insulating gas (closed, with natural ventilation or with forced ventilation), sided by the surfaces with a high degree of thermal radiation absorption.
having the cold surface separated from the rest of the wall by a thermos layer (with air, poor conductive gas or vacuum)
being reliable so that they need a minimum number of interventions
having as few as possible regulating elements or completely lacking them (by moving them in an accessible area)

All types of heat exchangers from the current technical level can be used:

1. Electric heat exchanger, made of a plate on which warm surface there are electric heater elements placed: a conductor with electric insulation placed in a winding position on the entire surface or only on some portions of the plate, tubular ceramic resistances or in a form of thin plates. One can use as well resistances that work based on Peltier effect, having the warm soldering in an interior active barrier and the cold soldering in an exterior barrier, reversing the functionalities during the summer.

2. Air heat exchanger, made of two plates (metallic, made of bricks, concrete, gypsum carton, polystyrene, resins, PVC, etc) or of pipes placed on a plate through which heated air is circulating in the winter or cold air in the summer. The surface of such an exchanger can be extended until all the exterior surface of the building is covered.

3. Water heat exchanger, that can be built in different variants: two impermeable walls (and in this case one can used materials not used in the current technical stage: composite materials, PVC, expanded polystyrene, impermeable concrete, depending on the temperature) through which the thermal agent is circulating; similar to a classic radiator of board type with horizontal or vertical columns; a thin metallic plate (can be a foil only) with a reflecting surface, having a winding pipe on the warm facet, preferably with horizontal arms, embedded in an accumulating mass (identical with the current floor or wall heating systems to which a thermos barrier is added). The entire system is thermal and hydraulic sized exactly like in a classic system (with which it can be combined), taking into account the special environment conditions where the heat exchange is happening. The distribution columns and the linkage pipes will be placed in the same plane as the exchanger or more towards interior. This type of exchanger can as well cover the entire surface of the building.

4. Heat exchangers with fridge agent, where the heat is brought by the latent heat of the agent. The exchanger is similar to water heat exchanger from constructive point of view, the size and the used materials are determined taking into account the chemical and physical properties of the used agent, of temperature interval and of pressure during usage, without significant differences between condenser and vaporizer, which allows reversing their roles depending on the season. This type of exchanger can be used as in classic climate circuits, the condenser and vaporizer being placed in the interior active barrier, respectively in the exterior one.

If the insulation of a building is made using thermal barriers as per this invention, because of small temperature differences on which heat changes are taking place, it is possible to build climate systems that don't need the usage of compressors. If in a thermos layer from an exterior wall or in an interior wall, false floor or false ceiling one is installing a heat exchanger with fridge agent with the pressure corresponding to a vaporizing temperature equal to the temperature of the environment where it is placed, without elements contributing to the temperature, this is acting as a thermal accumulator: when the environment temperature is decreasing by condensing a part of the gas agent, a certain amount of heat is released slowing the cooling process (when the temperature increases the effect is reversed by vaporization). If the pressure in the exchange is kept constant or increased by introducing an extra amount of gas, by connecting it to a tank or with a ventilator (in thin limits) or with a compressor, evacuating the corresponding liquid quantity (using gravitation or using a pomp), a continuous contribution with latent warm is realized. The system proposed in this invention contains a tank as main element (20a) with a fridge agent having the vaporizing point close to 20 Celsius degrees, crossed by a pipe system (20b) through which a heat carrier agent is passing, preferable water. During the winter the pipes can be sourced from a thermal tank, a solar panel, a geothermal well, a heat accumulator, etc. The thermal agent in the sink is recovering this heat, vaporizing and increasing its pressure. Using a distribution pipe system (20d) the agent is led to heat exchangers (20c) with fridge agent, classical ones or built as per this invention, allowing them ( ) in the exchanger via thermostatic valves where the are condensing on the walls, giving the latent heat. Another pipe system (20e) is collecting the additional liquid in the exchangers and is re-introducing it in the tank using a pomp (20f). During the summer the heat carrier agent can come from a chiller, from a fridge system with absorption based on the solar warm, from a phreatic or surface water layer, etc. The agent in the tank is condensing and is pushed by the pomp in the heat exchangers where it is vaporized absorbing heat and chilling the room. In some geographical areas in some periods of the year when day/night temperatures are oscillating around 20 Celsius degrees, the thermal carrier agent can be completed or replaced by two exterior tanks having variable resistance insulation. The night tank has the insulation open during the day capturing the heat from the environment, especially if the surface is heat absorbent and during the night, when the insulation is closed, it gives the heat to the tank with fridge agent. The day tank is cooling during the night and is absorbing heat from the tank during the night.

5. Heat economizer with fridge agent. Because of a very good insulation in the exterior of the building and due to large exchanging surfaces, the described heat exchangers are working on small temperature differences vs. the environment. When is needed for those differences to be higher, the cold surface temperature is increasing leading to a bigger temperature difference vs. the exterior environment, implicitly vs. the temperature gradient, which can lead to temperature losses higher than desired. Bringing this temperature difference into acceptable limits can be done introducing a heat economizer with fridge agent behind the exchanger or the thermos layer. This can be done by coupling two heat exchangers with fridge agent placed in environments with different temperatures, with the inner pressure corresponding to a vaporizing temperature intermediate between the two environments. This way the exchanger in the colder environment is becoming a condenser and the one in the warm environment is becoming a vaporizer. The exchangers are linked in the superior part with a gas pipe and in the inferior part with a liquid pipe, both of them well thermo insulated. The advantage of this type of economizer stands into the fact that when the agent is moving from one environment into the other, except for the heat carried because of the temperature difference there is also a transfer of vaporizing latent heat. Movement of the gas agent is done naturally, influenced by the pressure created during vaporizing, and the movement of the agent in liquid state is done gravitational when there is a favorable height difference or is done using a pomp. The choice of exact work pressure is done depending on the desired level of the agent in the two tanks and can be modified with a tampon tank and a pomp or a compressor. Because the interior pressured is adjusted so that the working temperature is established as an intermediate temperature between the two environments, one can obtain a heat transfer from the warmer mediums towards the cooler ones in the same room, the decrease of temperature behind a warm thermos, the increase of temperature behind a cold thermos, warming more rooms with the same exchanger, heating and intermediate thermos layer inside an exterior wall or a ceiling, with the heat taken from the ground, from the ground-water table, from a flowing water, etc. during the winter and in the same way chilling the layer during summer. The heat economizer 21c is placed around a concrete accumulator (21a) with a variable resistance vacuum barrier (21b) placed in the ground. In the cold periods it transfers the heat from the accumulator to the radiators 21d through a pipe system (21e), and in the warm periods it transfers in the ground the heat from the room.

Additionally, this type of economizer can be largely used for recovering the residual heat resulted from different thermal industrial processes, for using the geothermal water energy, using the heat from the ground, the flowing water or the heat generated by the solar panels.

6. Solar heat exchanger. This type of exchanger is placed in an active solar barrier. Due to its place and position, the optimal orientation of unitary panels would be difficult so it's preferable to have a panel based on lamellas or independent tubes, every lamella (tube) being able to rotate around its own axis to follow the sun. Because when the incident angle is small in the case of such an orientation, a large part of the capturing surface is shadowed by the neighboring lamellas it is recommended to place the lamellas in two different planes: a forward one with lamellas oriented towards sun (18f) and a backward one with the lamellas oriented towards the ground (18g), for capturing the diffuse radiations. Changing the positioning plane is done successively, in the same time with the change of the incident angle: for an angle smaller then π/2N (N=number of lamellas in a capturing module) the lamella in the far side of the module is in the first plane; for an angle in the interval π/2N−π/N a lamella from the middle of the module is brought in this plane, then two lamellas situated at one, respectively three quarters from the length of the module, reaching in the end when the incident angle is around π/2, all lamellas are in the forward plane, and after crossing this interval they return to the backward plane. Rotating the tubes around the axes and the movement from one plane to another is executed with some simple mechanisms (18h). A superior capturing degree is obtained if each tube is made of segments, each of them being able to orient in a perpendicular plane (18B). All types of capturing are possible: direct, with mirrors, with lens. Other elements proposed for increasing the capturing efficiency are:
using some fridge agents as carrier agents, having the vaporizing temperature in the interval of the working temperature, temperature that is adjusted depending on the exterior conditions by introducing or extracting a fraction from the total agent quantity. Through this change, the solar panel becomes a heat economizer as per this invention. The panels and lamella used in this case contain inside an evaporating chamber or a simple pipe system. The tubes used, including the ones with vacuum (19A), are crossed by a single pipe. The capturing elements are linked with flexible junctions (18e) to a pipe system (18j), movement of the agent being done gravitationally or with a pomp. Depending on the temperature of the vaporized gas, this can reach directly the heat exchangers in the rooms or a hot water boiler or a heat accumulator, while in the summer it can reach a chilling installation or an accumulator. A superior degree of accumulation can be reached if the agent is giving the heat to the vaporizer of a heat pomp (when exiting the vaporizer the agent can still contain the heat quantity needed to warm the room), which using the compressor is increasing the condensing temperature.
simultaneously using, in different circuits, in different concentric tubes, several fridge agents with different vaporizing temperatures, in increasing steps from exterior towards interior (19B, C)
simultaneously using, in a vacuum tube, several concentric tubes with thin walls, each containing a liquid with a different vaporizing temperature
chilling the surface of the concentrating mirrors, realizing behind them thin chambers containing a fridge agent, linked in the circuit of a heat pomp (19C.a)
placing on the interior wall of the solar module a semi-element of a heat economizer with fridge agent that will reduce the temperature difference vs. the temperature on the other side of the wall: if the active barrier formed by the capturing module is warm, by transferring a heat quantity towards the interior of the building, and if it is cold, by adding heat from the exterior air or from the ground
placing absorbing elements, concentrating mirrors or photovoltaic cells on the side walls

The solar barriers where these solar exchangers are placed can work on different temperatures:
the highest temperature given by insolation conditions. In this case, inside the barriers are placed:
   an absorbing wall, according to the current technical level, whose heat can be taken by an air current with natural or forced circulation that is washing both faces of the wall and sent directly to the air in the building or to some heat economizers (including a heat accumulator), classical ones or according to this invention
   an air, water or based on fridge agent heat exchanger, according to this invention, placed behind the wall, that is giving the temperature to a similar heat exchanger placed inside the building, to a heat accumulator or to the tank of an installation with fridge agent
   the vaporizer of a heat economizer placed behind the wall
   a solar plane according to the current technical level, whose heat can be taken from a heat carrier agent and given to some heat exchangers, classical ones or according to this invention, or to an accumulator or a tank
   a heat exchanger according to this invention with absorbing surface
   the vaporizer from a heat economizer, with absorbing surface
   a concentric solar tubes system, according to this invention, that is giving the heat to a thermal carrier agent
   a tube or lamella system according to this invention that are part of a heating system using fridge agent and a tank
   photo-voltaic cells for obtaining electric energy

The conditions of barrier usage are in a permanent change, the heat losses towards environment are high, the periods when the temperatures needed for operation are short.
for the temperature inside the building. In this case the temperature gradient of the wall is cancelled. This is obtained by chilling the entire interior space of the solar panel through the capturing elements of a heat pomp. The working conditions for the barrier are improved.
for a temperature equal or lower vs. the exterior environment. This is obtained by using the lamellas or solar tubes inside the panels, as thermal carrier agent for a fridge agent with the vaporizing temperature close to the exterior environment, the panels playing the role of a vaporizer of a heat pomp.

As well, the transparent panel can be doubled and a fridge agent with the vaporizing temperature close to the exterior environment temperature can be used between the two panels, the panel becoming in its turn the vaporizer of a heat pomp. In this case, based on the energy used by the heat pomp compressor, one is eliminating the loss towards exterior, is obtaining a high degree of capturing the diffuse radiation and allows the usage of the panels on any of the outside walls, no matter their orientation.

A special type of active barrier is the air between two windows of a window wall surface. This can be viewed as an intermediate barrier, being heated in the cold periods with small heat exchangers placed in the blinders used as variable resistance barriers, especially when they are closed, or in window bars (decorative elements), or as a solar barrier by placing some lamellas or solar tubes with fridge agent, with double role of blinders and solar energy trap.

1. Thermo insulating system called pellicullar gas barrier made by assembling the following elements in specialized workshops or on site:
Minimum 2 solid layers made of same or different materials, tough or flexible, compact, with small punches or woven (called support layers), placed between the protective layers, parallel to each other, and separated by them and between them by
Point like distancing elements, perimeter frame, grill, etc placed in between the support layers through sticking, adhesion or obtained by processing the support layers; when the distancing elements are missing, the support layers are fixed on the perimeter cover
One or more gas layers (called base layers), each placed between 2 support layers, unitary or divided by linear or grill like distancing elements
An outer cover (which ensures the mechanical protection and the assembly of the barrier) made in its turn from the following (independent, or built into a box, a bag or container) elements:
a. A protective outside layer (which can be the last support layer or the surface to be insulated)
b. An interior protector layer (which can be the last support layer or the surface to be insulated)
c. A perimeter cover, placed between the two protective layers, on their contour (which can be made of all the perimeter distance elements or of elements adjacent to the construction)
Optionally, in order to take part of the mechanical load of the cover:
d. One or more intermediate layers, parallel with the protective layers
e. One or more intermediate distance elements placed between the protective layers or between a protective and an intermediate layer
characterized by the fact that:
The thickness of the base layers is smaller than the minimal thickness (the thickness up until for the given temperature difference between the protective layers the convection and radiation heat transfer is negligible compared to the conductive heat transfer), limit that will be computed or experimentally determined.
The support layers are thinner than the base layers and are slightly tensioned, by adhesion or pressure of the corners and/or of the sides to the perimeter distancing elements and/or the perimeter cover
The number, shape, composition and size of distance elements are chosen so that the heat transfer through them is negligible versus the heat transfer through the base layer in which they are set
The weight of non convective gas volume in the total barrier volume is higher than 50%

2. (canceled)

3. (canceled)

4. (canceled)

5. Procedure for finding the limit thickness of the base layers in the pellicular gas barriers from claim 1, characterized by the fact that, for a certain pair of materials that compose the support layers and the base layers, a series of successive measurements of the thermal conductivity coefficient of the system is taken, starting form a minimal thickness that is successively increased by increasing the thickness of the perimeter distance elements, mentaining constant temperature between the protective layers.

6. Pellicular gas barrier as per claim 1 above named vacuum barrier, characterized by the fact that the pressure in at least one of the base layers is in the range of advanced vacuum, vacuum that can be periodically maintained turning on a vacuum pump coupled to the system; in the other layers the pressure is equal to the atmospheric pressure or is progressively decreasing from one layer to the other from the protective layers to the vacuum layer.

7. (canceled)

8. (canceled)

9. (canceled)

10. Thermo insulating system, as per claim 1 above, called thermos barrier, characterized by the fact that some base layers are bordered by reflecting or transparent surfaces.

11. Vacuum barrier, as per claims 6 above, characterized by the fact that the vacuum base layers are bordered by reflecting surfaces (vacuum thermos barrier).

12. (canceled)

13. (canceled)

14. Pellicular gas barrier, as per claim 1 above called active barrier, characterized by the fact that in one protective layer or in an intermediate layer (active layer) a positive or negative heat source is introduced: in order to flow the thermal radiations in the desired direction, one side of the active layer is reflecting surface and the other side is absorbing the radiations.

15. (canceled)

16. Pellicular gas barrier, as per claim 1 above called mobile barrier with variable resistance, characterized by the fact that one or more support layers can be distanced through flapping, sliding or rolling, allowing thus the thermo-insulating system to have different values for its thermal resistance, depending on the needs.

17. Device for protection and thermal screening for glassed surfaces of buildings and some installations (refrigerators, freezers), as well as for installations with periodical thermal processes and for parked autovehicles, characterized by the fact that it is a mobile barrier with variable resistance, as per claim 16, made of a bonnet manufactured from several fragments, from a soft thermo insulating material, and can have one or both surfaces reflecting surfaces, rolled in one or more fixed or mountable cassettes, and that can be freely rolled and then assembled with buttons, zippers, etc or are rolled so that the 2 sides of the bonnet are progressively inserted in a U shaped section frame.

18. Pellicular gas barrier, as per claim 1 above called fanned barrier with variable resistance, characterized by the fact that inside the walls of the exterior cover there are different devices used to easily replace the gas with a different fluid, stationary or moving one, in order to accelerate the heat transfer.

19. Pellicular gas barrier, as per claim 1 above named saturated barrier, characterized by the fact that the gas in some of the base layers is a cooling agent, with the pressure chosen such that for the maximum environmental temperature the vapors are saturated.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. Pellicular gas barrier as per claim 1 above called carrying multilayered barrier characterized by the fact it is made of a carrying exterior cover and a thermo insulating core.

34. Thermo insulating system, as per claim 1 above, characterized by the fact that there are built in valves inside the exterior walls, while in the support layers there holes are created for a non-convective flow of the gas, so that the air or gas in the base layers can be vacuumed, can have its pressure decreased or can be replaced with a different gas.

35. (canceled)

36. (canceled)

37. (canceled)

38. Vacuum barrier, as per claim 6 above, characterized by the fact that between the exterior and the vacuumed layers there are communication channels by linking more very long channels with low diameter (built on each of the support layers by cuts inside frames or by using linear spacing elements), each of those channels having one end open towards the corresponding base layer and the other end open towards the previous base layer trough a hole in the support layer, so that when the gas is periodically extracted from the vacuumed layer there is a pressure fall along the channel that is progressively reducing the pressure among the layers.

39. (canceled)

40. (canceled)

41. (canceled)

42. (canceled)

43. Thermo insulating system for clothes as per claim 1, characterized by the fact that the support layers are textile materials.

44. Thermo insulating system for new and old buildings, for pipes, tanks, thermal and fridge installations as well as their components, characterized by the fact that an independent supra-structure with its own foundation is built at a certain distance from the object to be insulated, surrounding it, with as few as possible contact points on it; on the inner side of the supra-structure and fixed to it or through other procedures, plates or thermo insulating mattresses manufactured as per claim 1 are set up, leaving an air layer between them and the object to be insulated; the insulated surface and the interior surface of the insulation can be both reflecting surfaces.

45. Thermo insulating system (porous walls) in the form of layers of plates manufactured as per claim 1 or through different procedures, placed such that one or two communication channels are built between the interior and exterior, channels through which there is a natural or forced air exchange, and simultaneously a thermal exchange between air and plates, recovering this way the heat of the disposed air.

46. (canceled)

47. Heat recovering device characterized by the fact that it is made of two active barriers as per claim 14, where the heat sources (one positive and one negative) are flat tanks containing a quantity of liquid refrigerant, the two active barriers are placed in different temperatures environments and are being linked between them on the superior side with a gas pipe and on the inferior side with a liquid pipe, on which a re-circulating pump is mounted if the flow is not gravitational.

48. Climate system made of active barriers with saturated cooling agent as per claim 47 above, characterized by the fact that both gas and liquid pipes of these barriers are linked to a tank with cooling agent where the heat exchange with a heat source is realized.

49. Climate system as per claim 48 above, characterized by the fact that the heat source is a fluid alternatively brought from two tanks with variable resistance placed in the outside environment, each tank having a time interval during which it exchanges heat with the environment (the other tank being active) and a time interval when there is a reversed heat exchange with the climate system.

50. Heat exchanger named solar barrier, characterized by the fact that it is manufactured out of a thermal radiations absorbing wall, oriented towards the sun, placed on the interior surface of a supra-structure realized as per claim 44, fixed to it or having its own foundation; on the exterior side of the supra structure a transparent wall or a radiation absorbent wall is set up; between the two walls, bordered on the side by the pillars and the beams of the supra structure, chambers are created in which the temperature is superior to the one of the environment and in which the components of an installation using the captured heat are placed.

51.-57. (canceled)
